(19) United States
(12) Patent Application Publication
(10) Pub. No.: US 2015/0183478 A1
(43) Pub. Date: Jul. 2, 2015

(54) BICYCLE ACCESSORY MOUNT

(71) Applicant: Tate Labs, Inc., Novato, CA (US)

(72) Inventors: Benjamin Duncan Tate, Novato, CA (US); Craig Michael Dennis, Golden, CO (US); Greg Scott Hillson, San Francisco, CA (US)

(21) Appl. No.: 14/643,676

(22) Filed: Mar. 10, 2015

Related U.S. Application Data
(63) Continuation-in-part of application No. 13/793,146, filed on Mar. 11, 2013.
(60) Provisional application No. 61/694,465, filed on Aug. 29, 2012.

(51) Int. Cl. B62J 11/00

(52) U.S. Cl. CPC B62J 11/00

(57) ABSTRACT

A bicycle accessory mount includes an engagement portion, a support portion, and an attachment portion. The engagement portion frictionally engages with a cylindrical component of a bicycle. The attachment portion attaches an accessory to the accessory mount. The support portion couples the engagement portion to the attachment portion and positions the accessory relative to a bicycle rider.

### CROSS-REFERENCE TO RELATED APPLICATIONS

This application is a continuation-in-part of U.S. patent application Ser. No. 13/793,146, filed Mar. 11, 2013 and entitled BICYCLE ACCESSORY MOUNT, which application claims priority to U.S. Provisional Patent Application Ser. No. 61/694,465, filed on Aug. 29, 2012, and entitled BICYCLE ACCESSORY MOUNT, the entireties of which applications are hereby incorporated by reference.

### FIELD OF THE INVENTION

The subject disclosure is directed to accessory mounting and, more specifically, relates to mounting accessories in relation to a target area or a bicycle component.

### BACKGROUND OF THE INVENTION

Bicycles are used for numerous applications. Exemplary bicycle types include road bicycles, touring bicycles, time trial bicycles, triathlon bicycles, BMX bicycles, Randonneur bicycles, Audax bicycles, hybrid bicycles, utility bicycles, mountain bicycles, freight bicycles, messenger bicycles, bicycle taxis, and motorized bicycles. Bicycles may be used for any suitable application, such as recreation, transportation, commuting, deliveries, taxi services, and commercial applications.

A bicycle rider may desire to attach accessories to the bicycle in a manner suitable for use of the accessories. Although any suitable accessories may be used by a rider, exemplary accessories include bicycle computers, speedometers, GPS devices, music players, telephones, triathlon watches, smart phones, mobile transmitters, Wi-Fi or other wireless communication devices, touch screen devices, any other suitable accessories, or any combination thereof. These accessories may be used to improve the experience of the rider for purposes such as recreation, transportation, commuting, deliveries, taxi services, and commercial applications. However, conventional accessory mounting solutions can suffer from a variety of deficiencies including inflexibility, an inability to support a variety device types, sizes, lack of robustness, complexity of use or manufacturing, and so on.

The above-described deficiencies of today's accessory mounting solutions are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY OF THE INVENTION

The following presents a simplified summary of the specification to provide a basic understanding of some aspects of the specification. This summary is not an extensive overview of the specification. It is intended to neither identify key or critical elements of the specification nor delineate any scope particular to any embodiments of the specification, or any scope of the claims. Its sole purpose is to present some concepts of the specification in a simplified form as a prelude to the more detailed description that is presented later.

In various embodiments, the present disclosure provides:

An accessory mount for positioning an accessory on a bicycle comprises an engagement portion defining an engagement surface adapted to frictionally engage with a cylindrical component of the bicycle, an attachment portion having a rotational attachment surface to fixedly attach the accessory to the accessory mount, and a support portion that couples the engagement portion to the attachment portion.

An accessory mount for positioning an accessory on a bicycle comprises an engagement portion defining an engagement surface adapted to frictionally engage with a cylindrical component of the bicycle, an attachment portion configured to fixedly attach the accessory to the accessory mount, and a support portion that couples the engagement portion to the attachment portion, wherein the support portion comprises an extension portion that extends from the engagement portion along a plane perpendicular to the axis of the cylindrical component of the bicycle, and a positioning portion that locates the rotational attachment surface at an offset to the extension portion.

A rotational attachment component of an accessory mount for positioning an accessory on a bicycle comprises a support portion, wherein the support portion comprises a coupling portion configured to couple the support portion to the accessory mount and a plurality of extension portions that extend from the coupling portion, and a plurality of ridges located on the extension portions and configured to fixedly attach the accessory to the accessory mount.

In further embodiments, the present disclosure provides an accessory mount for positioning a plurality of accessories relative to a cylindrical component of a bicycle. For example, disclosed embodiments can comprise an engagement portion defining an engagement surface adapted to frictionally engage the cylindrical component, an attachment portion having an attachment portion to fixedly attach accessory interfaces to the accessory mount, wherein the attachment portion is configured for simultaneous attachment of the accessory interfaces, and a support portion that couples the engagement portion to the attachment portion. In other embodiments, methods of mounting accessories to a cylindrical component of a bicycle are disclosed.

Further embodiments of the present disclosure provide a cantilevered object mount for locating an object relative to a target area. For example, disclosed embodiments can comprise an engagement portion of the cantilevered object mount defining engagement surfaces adapted to rest against complementary surfaces of the target area and employ weight of the cantilevered object mount to securely engage the cantilevered object mount on the target area, an attachment portion of the cantilevered object mount comprising a mounting head to fixedly attach a mounting platform to the cantilevered object mount, wherein the mounting head is configured to variably position the mounting platform, and a support portion of the cantilevered object mount that couples the engagement portion to the attachment portion. In still other embodiments, methods of locating an object relative to a target area are disclosed.

In addition, various other modifications, alternative embodiments, advantages of the disclosed subject matter, and improvements over conventional accessory mount designs are described.

These and other additional features of the disclosed subject matter are described in more detail below.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows an illustrative accessory mount attached to a cylindrical component of a bicycle in accordance with some embodiments of the present disclosure;

FIG. 2 shows a top view of an illustrative accessory mount in accordance with some embodiments of the present disclosure;

FIG. 3 shows a section view of an illustrative accessory mount in accordance with some embodiments of the present disclosure;

FIG. 4 shows a top view of an illustrative accessory mount in accordance with some embodiments of the present disclosure;

FIG. 5 shows a top view, a section view, and a bottom view of an illustrative rotational attachment component in accordance with some embodiments of the present disclosure;

FIG. 6 shows a perspective view of an exemplary accessory mount attached to a cylindrical component of a bicycle in accordance with further embodiments of the present disclosure;

FIG. 7 depicts an exploded view and an assembly of an exemplary accessory mount in accordance with embodiments of the present disclosure;

FIG. 8 shows top views, side views, a bottom view, and a section view according to non-limiting aspects of the present disclosure;

FIG. 9 shows a top view and a section view of an exemplary accessory interface according to various embodiments described herein;

FIG. 10 shows a top view and a section view of another exemplary accessory interface according to various embodiments described herein;

FIG. 11 depicts a top view, a front view, and an end view of another exemplary accessory mount in accordance with embodiments of the present disclosure;

FIG. 12 shows perspective views of a further exemplary accessory mount attached to cylindrical components of a bicycle in accordance with still further embodiments of the present disclosure;

FIG. 13 depicts an exploded view of an exemplary accessory mount and accessory interface in accordance with embodiments of the present disclosure;

FIG. 14 shows a top view, a side view, a bottom view, and section views according to non-limiting aspects of the present disclosure;

FIG. 15 shows perspective and section views of exemplary accessory interfaces according to various embodiments described herein;

FIG. 16 depicts a top view, a front view, an end view, and section views of another exemplary accessory mount in accordance with embodiments of the present disclosure;

FIG. 17 shows a perspective view of another exemplary accessory mount in accordance with further embodiments of the present disclosure;

FIG. 18 depicts a top view, a front view, and an end view of a further exemplary accessory mount in accordance with embodiments of the present disclosure;

FIG. 19 shows a perspective view of another exemplary accessory mount attached in accordance with further embodiments of the present disclosure;

FIG. 20 depicts a top view, a front view, and an end view of a further exemplary accessory mount in accordance with embodiments of the present disclosure;

FIG. 21 depicts a side view of an exemplary accessory mount according to non-limiting aspects of the present disclosure;

FIG. 22 depicts a side view of an exemplary cantilevered object mount according to non-limiting aspects of the present disclosure;

FIG. 23 shows a perspective view of an exemplary cantilevered object mount for locating an object relative to a target area in accordance with further embodiments of the present disclosure;

FIG. 24 shows a section view of an exemplary cantilevered object mount according to non-limiting aspects of the present disclosure;

FIG. 25 depicts an exploded view of an exemplary cantilevered object mount according to further non-limiting aspects of the present disclosure;

FIG. 26 depicts a further exploded view of an exemplary cantilevered object mount according to further non-limiting aspects of the present disclosure;

FIG. 27 shows a top view and a front view of an exemplary aspect of a cantilevered object mount in accordance with embodiments of the present disclosure;

FIG. 28 shows top view and a front view of an another exemplary aspect of a cantilevered object mount in accordance with embodiments of the present disclosure;

FIG. 29 shows a top view and an end view of another exemplary aspect of a cantilevered object mount in accordance with embodiments of the present disclosure;

FIG. 30 depicts a non-limiting flow diagram illustrating exemplary methods according aspects of the present disclosure; and

FIG. 31 depicts another non-limiting flow diagram illustrating exemplary methods according aspects of the present disclosure.

### DETAILED DESCRIPTION OF ILLUSTRATIVE EMBODIMENTS

### Overview

While a brief overview is provided, exemplary accessory and/or object mounts are described herein for the purposes of illustration and not limitation. For example, one skilled in the art can appreciate that the illustrative embodiments can have application with respect to other mounting technologies.

Bicycles are used for numerous applications. Exemplary bicycle types include road bicycles, touring bicycles, time trial bicycles, triathlon bicycles, BMX bicycles, Randonneur bicycles, Audax bicycles, hybrid bicycles, utility bicycles, mountain bicycles, freight bicycles, messenger bicycles, bicycle taxis, and motorized bicycles. Bicycles may be used for any suitable application, such as recreation, transportation, commuting, deliveries, taxi services, and commercial applications.

A bicycle rider may desire to attach accessories to the bicycle in a manner suitable for use of the accessories. Although any suitable accessories may be used by a rider, exemplary accessories include bicycle computers, speedometers, GPS devices, music players, telephones, triathlon watches, smart phones, mobile transmitters, Wi-Fi or other wireless communication devices, touch screen devices, any other suitable accessories, or any combination thereof. These accessories may be used to improve the experience of the rider for purposes such as recreation, transportation, commuting, deliveries, taxi services, and commercial applications.

As described in the background, conventional accessory mounting solutions and methods suffer from drawbacks associated with inflexibility, an inability to support a variety device types, sizes, and so on.

### Exemplary Non-Limiting Embodiments

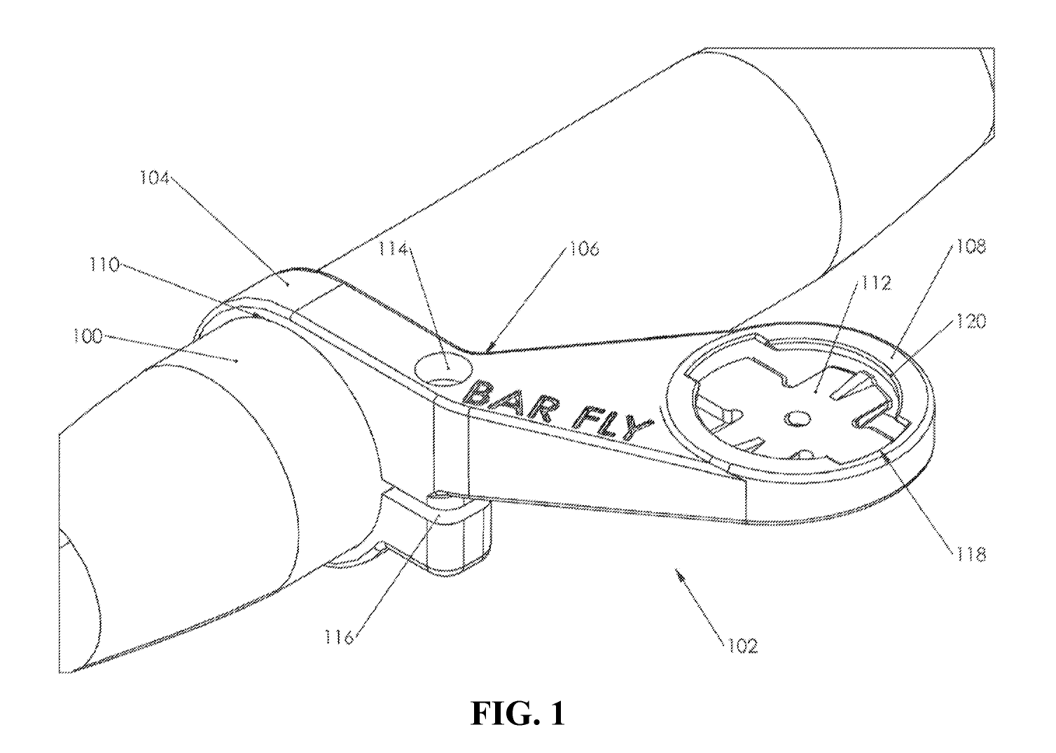

FIG. 1 depicts an accessory mount for a bicycle in accordance with some embodiments of the present disclosure. As will be described herein, accessories may be fixedly attached to the accessory mount, and the accessory mount may engage with the bicycle. Although the accessory mount will be described herein as engaging with a cylindrical component of the bicycle, it will be understood that the accessory mount may be configured in any suitable manner to engage with non-cylindrical bicycle components.

An exemplary bicycle may include a number of cylindrical components, such as the bicycle frame, seat post, and handlebars. Although an accessory mount may be configured to attach to any suitable bicycle component, in an exemplary embodiment, the accessory mount may be configured to attach to the bicycle handlebars in a manner that positions the accessory for ease of viewing and/or access by the rider. In exemplary embodiments, an accessory mount that engages with a cylindrical component may be located by the user at any suitable location of the bicycle wherein the cylindrical component has a diameter that engages with a diameter associated with an engagement surface of an engagement portion of the accessory mount, as described herein. For example, in some embodiments, components such as handlebars (e.g., drop bars, track bars, ergo bars, Randonneur bars, drop-in bars, riser bars, upright bars, Pourteur bars, touring bars, trekking bars, triathlon bars, aerobars, pursuit bars, BMX bars, cruiser bars, moustache bars, ape hanger bars, recumbent bars, or Whatton bars) may include generally cylindrical portions, and exemplary bicycles may be configured to accept any handlebars having a standard handlebar diameter (e.g., 31.8 mm diameter handlebars, 22-23 mm diameter aero bars, or any other suitable standardized dimensions).

Referring to FIG. 1, an accessory mount 102 may be engaged with a cylindrical component 100. The accessory mount may include an engagement portion 104, a support portion 106, and an attachment portion 108. Although a single engagement portion 104 is depicted, it will be understood that any suitable number of engagement portions 104 may be used to engage the accessory mount 102 to the cylindrical component 100. For example, in an exemplary embodiment (not depicted), two or more engagement portions 104 may be coupled to support portion 106 and engaged with the cylindrical component 100. Although a single attachment portion 108 is depicted, it will be understood that any suitable number of attachment portions 108 may be used to attach accessories (not depicted) to the accessory mount 102. For example, in an exemplary embodiment (not depicted), two or more attachment portions 108 may be coupled to support portion 106 for attachment of two or more accessories to accessory mount 102. In another embodiment, a plurality of different types of attachment portions 108 (e.g., utilizing quarter turn mount, eighth turn mount, rotational mount, screw mount, sliding mount, or any other suitable attachment mechanism) may be coupled to support portion 106 for attachment of two or more accessories to accessory mount 102.

In an exemplary embodiment, engagement portion 104, support portion 106, and attachment portion 108 may be a unitary component as depicted in FIG. 1. However, it will be understood that each of engagement portion 104, support portion 106, and attachment portion 108 may be constructed of two or more components in any suitable manner. It will be understood that accessory mount 102 may include any additional suitable portions or components (not depicted), and that each of engagement portion 104 and attachment portion 108 may be coupled to support portion 106 in any suitable manner, including with additional intervening portions or components.

Accessory mount 102 may be constructed of any suitable material or combination of materials, including metals (e.g., aluminum), polymers, composites, ceramics, any other suitable material, or any combination thereof. In an exemplary embodiment, accessory mount 102 may be constructed of an acetal polymer such as Delrin. Although it will be understood that any suitable material may be selected for any suitable application, an acetal polymer such as Delrin may provide a flexibility that allows an opening 116 of engagement portion 104 to be expanded to be flexibly pulled over cylindrical component 100, may have properties that permit suitable frictional engagement with cylindrical component 100, and may provide stability and robustness for supporting an accessory (not depicted) upon attachment portion 108.

Engagement portion 104 may provide for frictional engagement with cylindrical component 100. Engagement portion 104 may include an interior engagement surface 110 that frictionally engages with cylindrical component 100. The width of engagement portion 104 may define a surface area of engagement surface 110 that frictionally engages with cylindrical component 100, and may be any suitable width to provide a degree of friction suitable for a particular application and a desired degree of frictional engagement. Although engagement portion 104 may have any suitable thickness, in an exemplary embodiment, a thickness may be suitable to allow engagement portion 104 to be flexibly pulled over cylindrical component 100.

Support portion 106 may couple engagement portion 104 to attachment portion 108. Support portion 106 may be constructed in any suitable manner to accommodate any suitable engagement portion 104, plurality of engagement portions 104, attachment portion 108, plurality of attachment portions 108, any other suitable components or attachments, or any combination thereof. In an exemplary embodiment as depicted herein a single engagement portion 104 may be coupled to a single attachment portion 108.

Although the engagement portion 104, support portion 106, and attachment portion 108 may be configured in any suitable manner to define any suitable relative position of attachment portion 108 to engagement portion 104, in an exemplary embodiment, the attachment portion 108 may be positioned such that a rotational attachment surface 112 is on a plane that is substantially tangentially aligned with the cylindrical component 100. For example, if accessory mount 102 is attached to bicycle handlebars, an accessory attached to accessory mount 102 may be located in front of the bicycle handlebars for ease of viewing and/or access. In other exemplary embodiments, attachment portion 108 may be positioned in a manner such that rotational attachment surface 112 is on a plane that is substantially perpendicular to the axis of cylindrical component 100, in a manner such that rotational attachment surface 112 is on a plane that is substantially aligned with the axis of cylindrical component 100, or in any other suitable manner that defines a desired relationship between a plane corresponding to rotational attachment surface 112 and cylindrical component 100.

In the exemplary embodiment depicted in FIG. 1, support portion 106 may include an extension portion that extends along a plane perpendicular to the axis of cylindrical component 100 and a positioning portion that locates rotational attachment surface 112 relative to the extension portion. In an exemplary embodiment, the positioning portion of support portion 106 may locate the rotational attachment surface 112 at an offset from the extension portion as depicted in FIG. 1. In an exemplary embodiment where the accessory mount is located adjacent to a bicycle stem component, the offset may allow for a centered location of the accessory that is attached to attachment portion 108. Although support portion 106 may have any suitable relative shape, in an exemplary embodiment, support portion 106 may be tapered as depicted in FIG. 1. Although support portion 106 may be constructed in any suitable manner (e.g., solid, partially hollowed, recessed, etc.), in an exemplary embodiment, support portion 106 may be recessed with a suitable wall thickness, for example, along the surface opposite rotational attachment surface 112.

An engagement component (not depicted) may be utilized to fix, lock, and/or adjust the engagement of engagement surface 110 to cylindrical component 100. Exemplary engagement components may include one or more of bolts, screws, locks, levers, latches, magnets, clamps, adhesives, any other suitable engagement component, or any combination thereof. In an exemplary embodiment, accessory mount 102 may include an engagement cavity 114 that allows for a bolt to be used as an engagement component. Engagement cavity 114 may be recessed to allow a bolt to be fully recessed within accessory mount 102. Although accessory mount 102 may engage the threads of the bolt in any suitable manner, in an exemplary embodiment, a threaded insert (not depicted) may be inserted (e.g., with a press fit, adhesive, or in any other suitable manner) into accessory mount 102, such that an interior surface of the insert may engage the threads of the bolt. The tightening of the bolt may close opening 116 of accessory mount 102, as well as adjusting the frictional engagement of the engagement surface 110 of engagement portion 104 to cylindrical component 100.

Attachment portion 108 may be constructed in any suitable manner to fixedly attach one or more accessories to accessory mount 102, such as rotational attachment, slidable attachment, attachment via screws, attachment via bolts, attachment via locks, attachment with tabs, any other suitable attachment mechanism, or any combination thereof. Although some accessories may include an interface that is compatible with attachment portion 108 of accessory mount 102, in some embodiments an accessory interface (not depicted) may be provided for accessories. An exemplary accessory interface may include a compatible portion to attach to attachment portion 108, and may attach to the accessory in any suitable manner, such as a sleeve, an adapter for an attachment component of the accessory, screws, bolts, clamps, adhesives, magnets, any other suitable attachment mechanism, or any combination thereof. In an exemplary embodiment, a sleeve may substantially encase a smart phone, and may include a compatible portion to attach to attachment portion 108. An exemplary smart phone can thus run any suitable program or “app” utilizing any suitable hardware and software of the smart phone.

Although rotational attachment may be implemented in any suitable manner, in an exemplary embodiment, attachment portion 108 may provide for rotational attachment of accessories to attachment mount 102. Attachment portion 108 may include one or more attachment slots 118, a retaining lip 120, and attachment surface 112. A compatible portion of an accessory or accessory interface may include one or more retaining tabs that slidably fit within attachment slots 118, and may have an appropriate clearance to be seated on attachment surface 112 under retaining lip 120. In an embodiment, the accessory or accessory interface may be rotated until the one or more ridges of attachment surface 112 engage with a corresponding one or more recesses or detents of the compatible portion of the accessory or accessory interface. The one or more ridges of attachment surface 112 may prevent rotational movement of the accessory or accessory interface during use, and may apply a corresponding pressure between the retaining lip of attachment portion 108 and the retaining tab of the accessory or accessory interface. It will be also be understood that, in some embodiments, attachment portion 108 may attach to the accessory or accessory interface based on a relationship with the retaining tabs of the accessory or accessory interface, for example, by providing one or more tabs or ridges that engage with a side surface of the retaining tabs. It will also be understood that any suitable combination of attachment methods may be utilized.

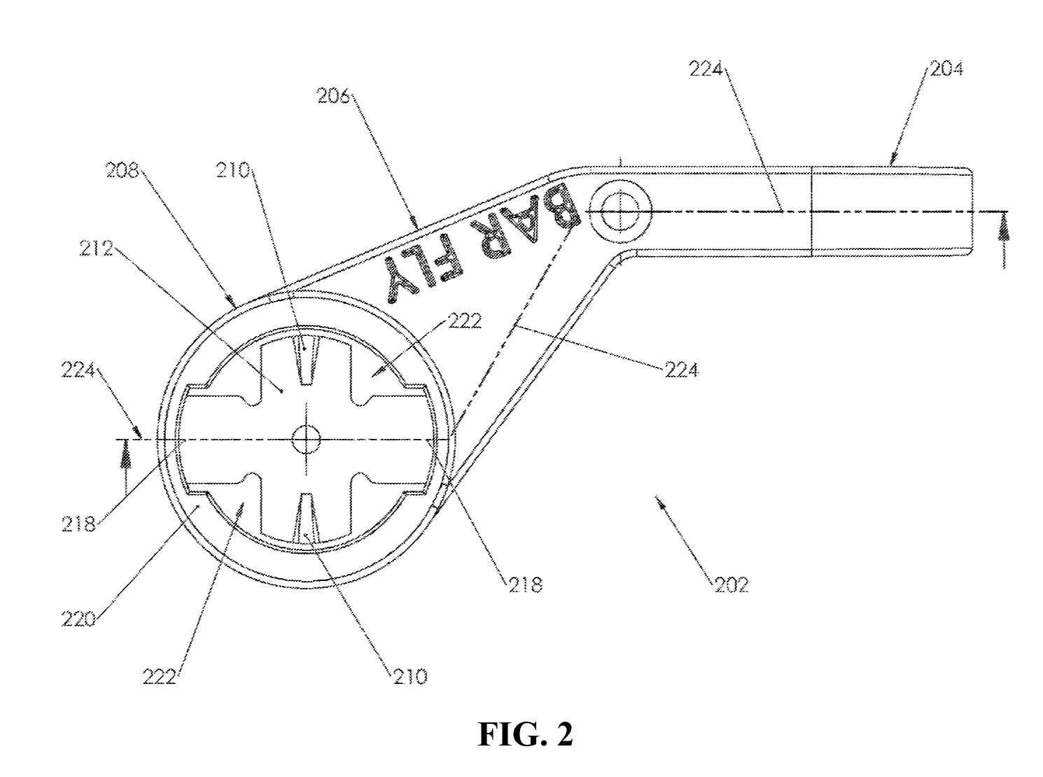

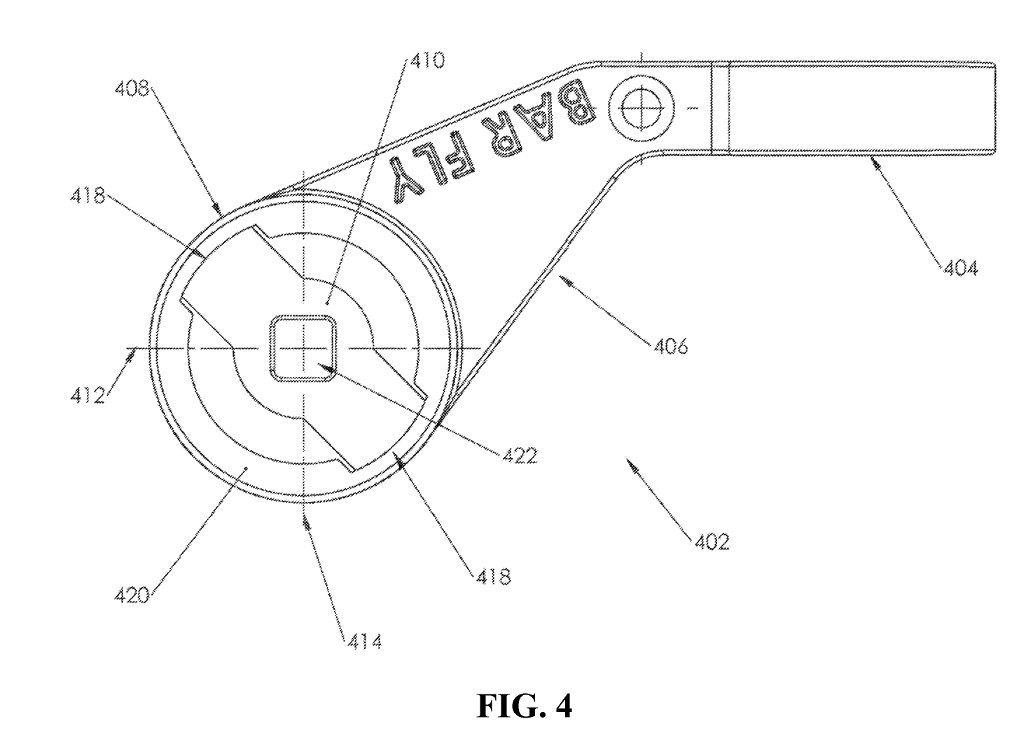

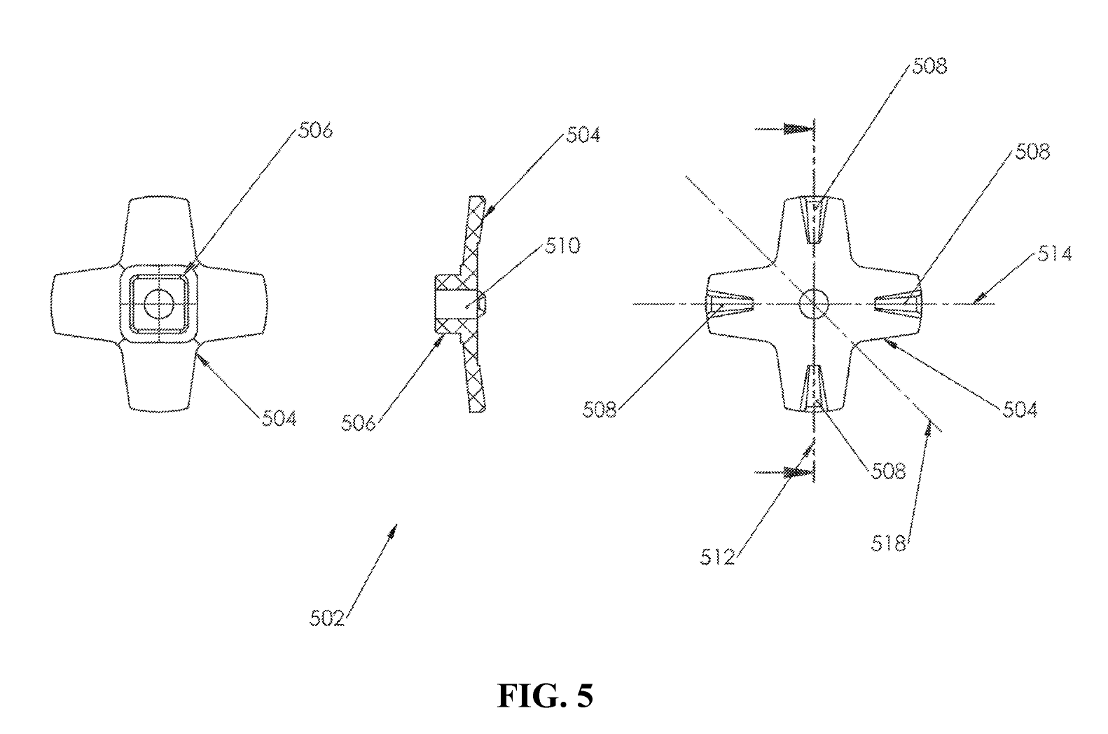

FIG. 2 depicts a top view of an illustrative accessory mount in accordance with some embodiments of the present disclosure. Accessory mount 202 may include engagement portion 204, support portion 206, and attachment portion 208. FIG. 2 may depict an exemplary embodiment of attachment portion 208, which may be described as a quarter turn rotational attachment component. It will be understood that any suitable attachment portion may be implemented as attachment portion 208 (e.g., an eighth turn attachment portion as described with respect to FIGS. 4-5). Although attachment portion 208 may include any suitable components, in an exemplary embodiment, attachment portion 208 may include rotational attachment surface 212, ridges 210 located on rotational attachment surface 212, retaining lip 220, and attachment slots 218.

Although the components of attachment portion may be configured in any suitable manner, in an exemplary embodiment, two attachment slots 218 are arranged at opposite ends of retaining lip 220 at 90° angles to ridges 210. Although attachment portion 208 is depicted as a single component attached in FIG. 2, it will be understood that attachment portion 208 may be constructed in any suitable manner. For example, attachment surface 212 may be part of a component that can attach within attachment portion 208 at a plurality of orientations in a manner to allow ridges 210 to be positioned at a plurality of different orientations in a manner that allows for accessories to be positioned at a plurality of angles relative to a rider.

Although rotational attachment surface 212 may be coupled to other components of attachment portion 208 in any suitable manner, in an exemplary embodiment, rotational attachment surface 212 may be coupled to other components of attachment portion 208 at locations that correspond to attachment slots 218. Rotational attachment surface 212 may define attachment gaps 222, which in some embodiments may provide additional points of contact with a compatible portion (e.g., retaining tabs) of an accessory or accessory interface. Although two attachment gaps are depicted, and the attachment gaps are depicted in a particular arrangement, it will be understood that any quantity of attachment gaps may be arranged in any suitable manner. Ridges 210 may protrude from rotational attachment surface 212. Although any number of ridges 210 may be arranged in any suitable manner on rotational attachment surface 212, in an exemplary embodiment, two ridges 210 may be arranged perpendicular to attachment slots 218.

In an exemplary embodiment, a compatible portion of an accessory or accessory interface is inserted into attachment slots 218, and rotated in a manner such that the retaining tab of the compatible portion of the accessory engages with retaining lip 220 of attachment portion 208. The compatible portion of the accessory or accessory interface may include a recess or detent that may engage with ridges 210 of attachment portion 208 to fixedly attach the accessory or accessory interface. In an embodiment the recess or detent may be located to engage the ridges when the accessory or accessory interface is turned 90° in either the clockwise or counter-clockwise direction (i.e., a quarter turn).

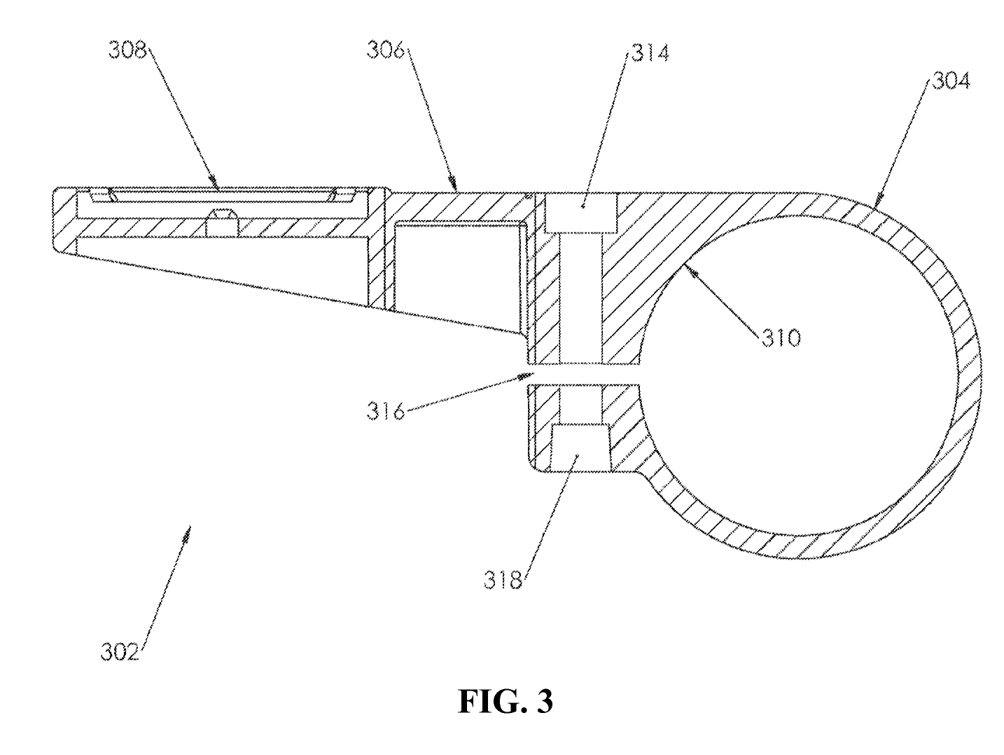

FIG. 3 shows a section view of an illustrative accessory mount in accordance with some embodiments of the present disclosure. The depicted section view corresponds to section line 224 of FIG. 2. Accessory mount 302 may include engagement portion 304, support portion 306, and attachment portion 308. In some embodiments, engagement portion 304 may engage with a component of a bicycle in any suitable manner, such as bolts, screws, locks, levers, latches, magnets, clamps, adhesives, or any combination thereof. As is depicted in FIG. 3, and in an exemplary embodiment, engagement portion 304 may define an engagement surface 310 that frictionally engages with a cylindrical component of a bicycle. Engagement surface 310 may have any suitable shape to frictionally engage with a surface such as a cylindrical surface of a bicycle, and in some embodiments may only partially engage with the component of the bicycle. In an exemplary embodiment, engagement surface 310 may define a circular engagement surface.

Although engagement surface 310 may be engaged with the cylindrical component of the bicycle in any suitable manner, in an exemplary embodiment, an opening 316 may allow accessory mount 302 to be flexibly pulled over the cylindrical component of the bicycle to engage with engagement surface 310. In an exemplary embodiment, opening 316 may be configured to be closed when a single engagement component (not depicted) fixes, locks, and/or adjusts engagement portion 304 of the accessory mount 302. Although an embodiment relating to a flexible accessory mount 302 and an opening 316 is described herein, it will be understood that an engagement portion may also include a plurality of components that may be coupled together without flexibly pulling the accessory mount over the cylindrical component of the bicycle.

Although an engagement component may be implemented in any suitable manner as described herein, in an exemplary embodiment, an engagement cavity 314 may define a cavity for a bolt (not depicted) and threaded insert (not depicted) to provide for the engagement and adjustment of engagement surface 310 relative to the cylindrical component. In an exemplary embodiment, the threaded insert may be located within a first portion 318 of the engagement cavity 314.

FIG. 4 shows a top view of an illustrative accessory mount in accordance with some embodiments of the present disclosure. Accessory mount 402 may include engagement portion 404, support portion 406, and attachment portion 408. The accessory mount depicted in FIG. 4 may be similar to the accessory mount depicted in described an FIGS. 1-3, with a different relative positioning of the attachment portion relative to the cylindrical component of the bicycle (e.g., based on the positioning portion of support portion 406) and having an attachment portion 408 that includes a two-part attachment component (e.g., an eighth turn attachment component) as described with respect to FIGS. 4-5.

An attachment portion 408 may include a seating portion 410, attachment slots 418, retaining lip 420, and a rotational attachment component 502 (depicted and described with respect to FIG. 5) that may be fastened to seating portion 410. Seating portion 410 may support rotational attachment component 502 and provide a fastening surface for rotational attachment component 502. Although rotational attachment component 502 may be fastened to seating portion 410 in any suitable manner, in an exemplary embodiment, seating portion 410 may define a though hole 422 that interfaces with a fastening portion of rotational attachment component 502 as described herein. In some embodiments, seating portion 410 may be configured in a manner to allow rotational attachment component 502 to be positioned at a plurality of rotational orientations.

Although an accessory may attach to the attachment portion 408 in any suitable manner, in an exemplary embodiment, attachment portion 408 may implement an eighth turn rotational attachment component. An eighth turn rotational attachment component may allow accessories to be oriented in at least four orientations, each corresponding to a set of two ridges. When the rotational attachment component of FIG. 5 is fastened to seating portion 410, a set of two ridges may be aligned along each of planes 412 and 414. This arrangement may provide for four orientations of the accessory or accessory interface, one in each direction of each of planes 412 and 414.

Although attachment slots 418 may be oriented in any suitable manner in comparison to planes 412 and 414, in an exemplary embodiment, attachment slots 418 may be oriented at a 45° angle to planes 412 and 414. In an exemplary embodiment, the recesses or detents of an accessory may be located on a bottom surface of the attachment tabs of the accessory. If the recesses or detents of the accessory are aligned with the retaining tabs of the accessory, an eighth turn (or 45° turn) of an accessory that is inserted into attachment portion 408 through attachment slots 418 in the clockwise direction may align the retaining tabs of the accessory (and thus the recesses or detents) with the ridges on plane 414, while an eighth turn (or 45° turn) of an accessory in the counter-clockwise direction may align the retaining tabs of the accessory (and thus the recesses or detents) with ridges on plane 412. In this manner, the accessory may be rotated to any of the four possible orientations by a rider in order to obtain the desired orientation of the accessory.

FIG. 5 shows a top view, a section view, and a bottom view of an illustrative rotational attachment component 502 in accordance with some embodiments of the present disclosure. Rotational attachment component 502 may include support surface 504, fastening portion 506, and ridges 508. Although support surface 504 may be configured in any suitable manner, in an exemplary embodiment, support surface 504 may include a coupling portion coupled to fastening portion 506 and a plurality of extensions associated with ridges 508. Although the extensions may be configured in any suitable manner, in an exemplary embodiment, an extension may be associated with each of ridges 508. In an embodiment, a coupling portion of support surface 504 may include a through hole 510.

Fastening portion 506 may be configured to fasten rotational attachment component 502 to seating portion 410 of accessory mount 402. Although rotational attachment component 502 may be attached to seating portion 410 in any suitable manner (e.g., bolts, screws, locks, levers, latches, magnets, clamps, adhesives, any other suitable attachment method, or any combination thereof), in an exemplary embodiment, fastening portion may provide for a press fit with through hole 422 of seating portion 410. In an embodiment, a tab (not depicted) may be located on fastening portion 506 to fixedly attach to an opposite surface of seating portion 410 when fastening portion is inserted into through hole 422.

Although any suitable number of ridges 508 may be included on rotational attachment component 502, and ridges 508 may be arranged on support surface portion 504 in any suitable manner, in an exemplary embodiment, four ridges 508 may be located at 90° angles on planes 512 and 514 (which may be associated with planes 412 and 414, respectively) in a manner that implements an eight turn rotational attachment component. A plane 518 may correspond to attachment slots 418 depicted in FIG. 4.

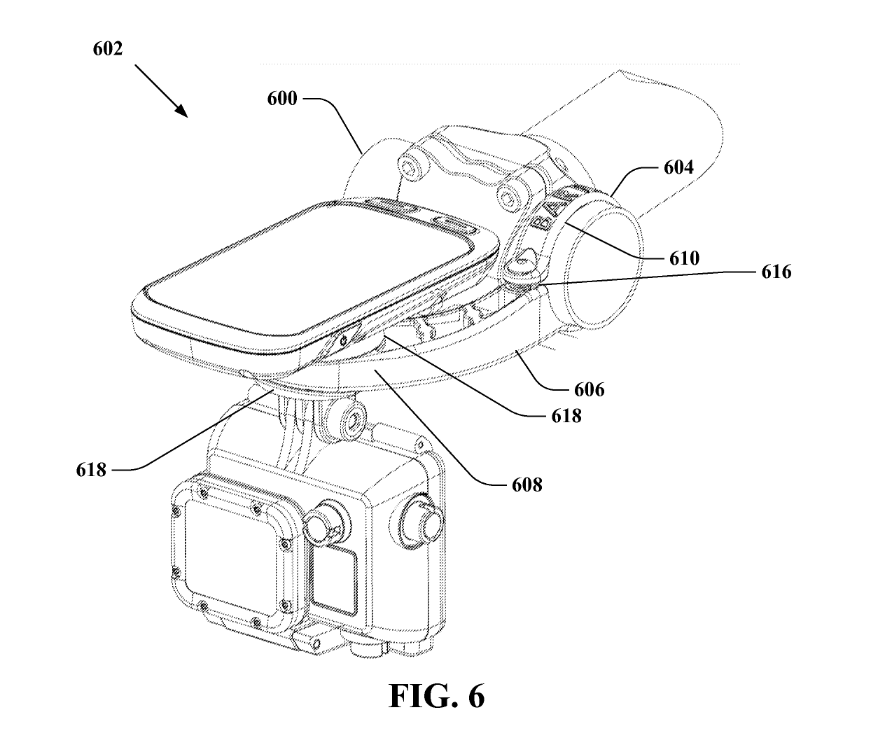

FIG. 6 shows a perspective view of an exemplary accessory mount 602 attached to a cylindrical component 600 of a bicycle in accordance with further embodiments of the present disclosure. The accessory mount 602 may include an engagement portion 604, a support portion 606, and an attachment portion 608. Although a single engagement portion 604 is depicted, it will be understood that any suitable number of engagement portions 604 may be used to engage the accessory mount 602 to the cylindrical component 600. For example, in an exemplary embodiment (not depicted), two or more engagement portions 604 may be coupled to support portion 606 and engaged with the cylindrical component 600. Although a single attachment portion 608 is depicted, it will be understood that any suitable number of attachment portions 608 may be used to facilitate attaching accessories to the accessory mount 602. For example, in an exemplary embodiment (not depicted), two or more attachment portions 608 may be coupled to support portion 606 for attachment of two or more accessories to accessory mount 602. In another exemplary embodiment, attachment portion 608 facilitates fixedly attaching two or more accessory interfaces 618, and can be coupled to support portion 606 for attachment of two or more accessories to accessory mount 602. In yet another embodiment, a plurality of different types of accessory interfaces 618 may be fixedly attached to an attachment portion 608 for attachment of two or more accessories to accessory mount 602.

In an exemplary embodiment, each of engagement portion 604, support portion 606, and attachment portion 608 may be constructed of two or more components in any suitable manner as depicted in FIG. 6. However, it will be understood that engagement portion 604, support portion 606, and attachment portion 608 may comprise a unitary component. It will be understood that accessory mount 602 may include any additional suitable portions or components (not depicted), and that each of engagement portion 604 and attachment portion 608 may be coupled to support portion 606 in any suitable manner, including with additional intervening portions or components.

As with accessory mount 102 regarding FIG. 1, accessory mount 602 may be constructed of any suitable material or combination of materials, including metals (e.g., aluminum, magnesium), polymers, composites, ceramics, any other suitable material, or any combination thereof. In an exemplary embodiment, accessory mount 602 may be constructed of an acetal polymer such as Delrin. Although it will be understood that any suitable material may be selected for any suitable application, an acetal polymer such as Delrin may provide a flexibility that allows an opening 616 of a unitary engagement portion 604 to be expanded to be flexibly pulled over cylindrical component 600, may have properties that permit suitable frictional engagement with cylindrical component 600, and may provide stability and robustness for supporting an accessory upon attachment portion 608.

Engagement portion 604 may provide for frictional engagement with cylindrical component 600. Engagement portion 604 may include an interior engagement surface 610 that frictionally engages with cylindrical component 600. The width of engagement portion 604 may define a surface area of engagement surface 610 that frictionally engages with cylindrical component 600, and may be any suitable width to provide a degree of friction suitable for a particular application and a desired degree of frictional engagement. Although engagement portion 604 may have any suitable thickness, in an exemplary embodiment, a thickness may be suitable to allow engagement portion 604 to be flexibly pulled over cylindrical component 600.

Support portion 606 may couple engagement portion 604 to attachment portion 608. Support portion 606 may be constructed in any suitable manner to accommodate any suitable engagement portion 604, plurality of engagement portions 604, attachment portion 608, plurality of attachment portions 608, any other suitable components or attachments, or any combination thereof. In an exemplary embodiment as depicted herein a single engagement portion 604 may be coupled to a single attachment portion 608.

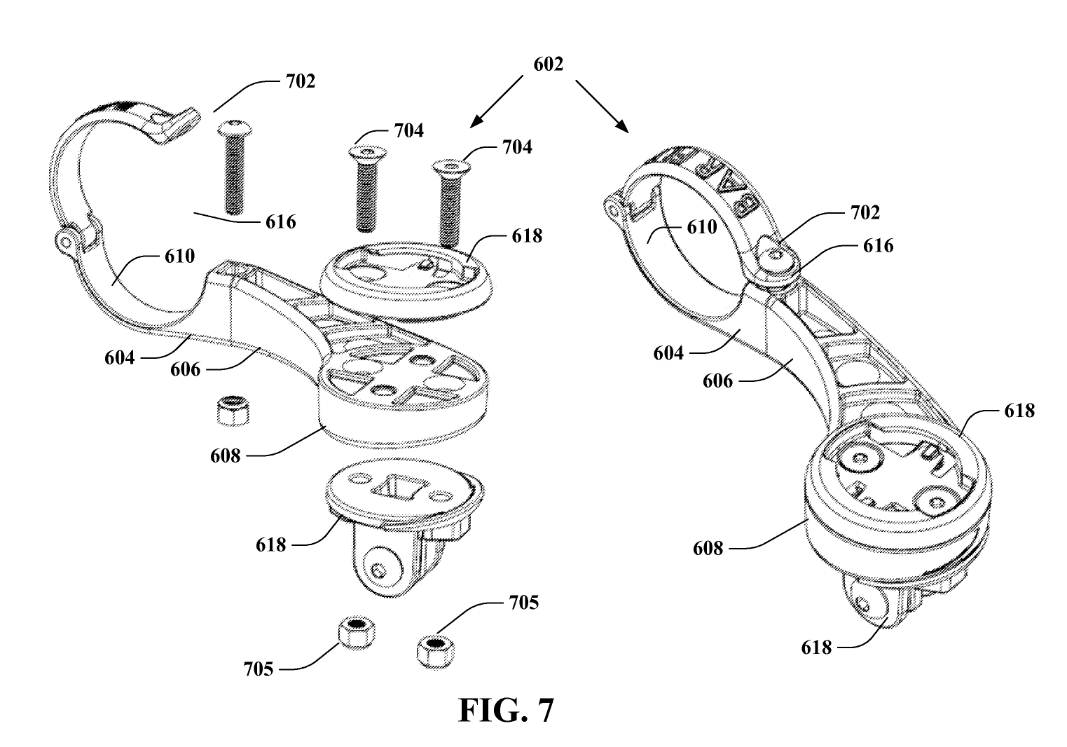

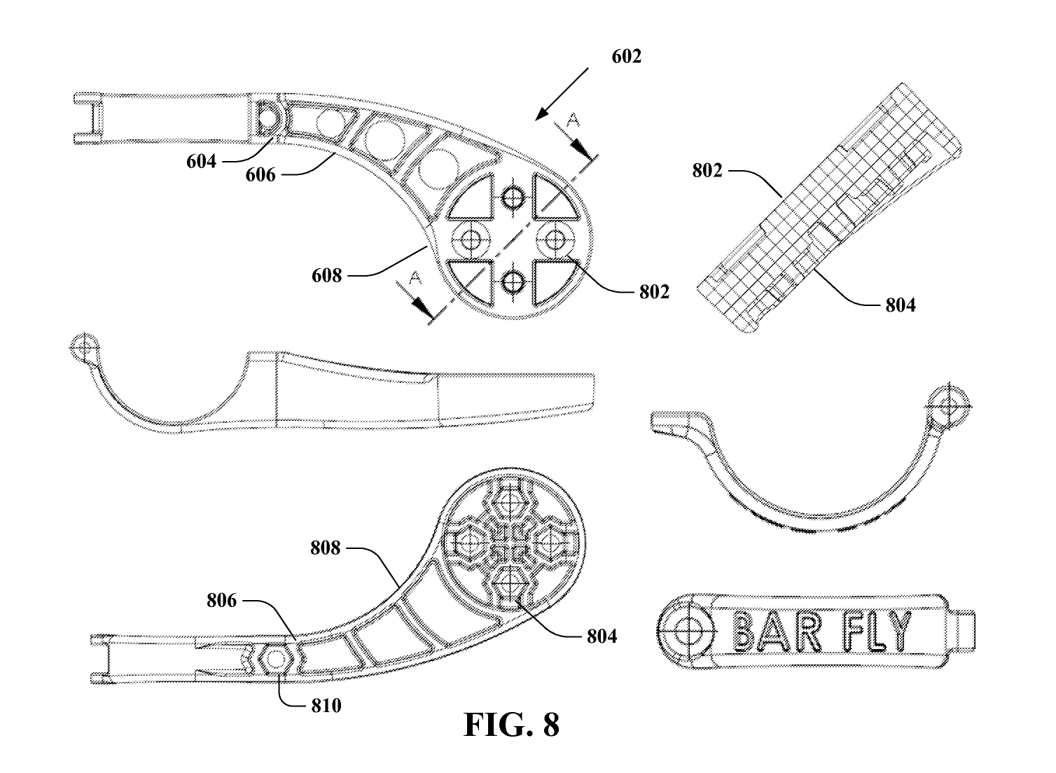

FIG. 7 depicts an exploded view and an assembly view of an exemplary accessory mount 602 in accordance with embodiments of the present disclosure. FIG. 8 shows top views, side views, a bottom view, and a section view according to non-limiting aspects of the present disclosure. A plurality of different types of accessory interfaces 618 may be fixedly attached to an attachment portion 608 for attachment of two or more accessories to accessory mount 602. Accordingly, in the exemplary embodiments of FIGS. 6-8, attachment portion 608 can comprise a plurality of mounting surfaces (e.g., mounting surface 802, mounting surface 804, etc.), wherein each of the plurality of mounting surfaces can be adapted to attach one or more of a plurality of accessory interfaces 618. Thus, in a non-limiting aspect, an exemplary attachment portion 608 can be configured for simultaneous attachment of a plurality of accessory interfaces 618, as depicted in FIG. 6, for example. As a result, in a further non-limiting aspect, a plurality of accessory interfaces 618 can be configured for simultaneous attachment of one or more different accessories to the attachment portion 608, as depicted in FIG. 6, for example.

In an exemplary embodiment, as depicted in FIG. 8, for example, two of the plurality of mounting surfaces (e.g., mounting surface 802, mounting surface 804, etc.) can be located on opposite sides of the attachment portion 608. However, it will be understood that any suitable number of the plurality of mounting surfaces (e.g., mounting surface 802, mounting surface 804, etc.) can be located in any suitable manner relative to any number of sides of the attachment portion 608 (not depicted).

In addition, although the engagement portion 604, support portion 606, and attachment portion 608 may be configured in any suitable manner to define any suitable relative position of attachment portion 608 to engagement portion 604, in an exemplary embodiment, the attachment portion 608 and/or one or more of the plurality of mounting surfaces (e.g., mounting surface 802, mounting surface 804, etc.) may be positioned such that a plane defined by at least one of the plurality of mounting surfaces is substantially tangentially aligned with the cylindrical component 600. For example, if accessory mount 602 is attached to bicycle handlebars, an accessory attached to accessory mount 602 may be located in front of the bicycle handlebars for ease of viewing and/or access. In other exemplary embodiments, attachment portion 608 may be positioned in a manner such that the attachment portion 608 and/or one or more of the plurality of mounting surfaces (e.g., mounting surface 802, mounting surface 804, etc.) may be positioned such that a plane defined by at least one of the plurality of mounting surfaces is substantially perpendicular to the axis of cylindrical component 600, in a manner such that an attachment portion 608 and/or one or more of the plurality of mounting surfaces (e.g., mounting surface 802, mounting surface 804, etc.) is on a plane that is substantially aligned with the axis of cylindrical component 600, or in any other suitable manner that defines a desired relationship between a plane corresponding to an attachment portion 608 and/or one or more of the plurality of mounting surfaces (e.g., mounting surface 802, mounting surface 804, etc.) and cylindrical component 600.

In the exemplary embodiments depicted in FIGS. 6-8, support portion 606 may include an extension portion 806 that extends along a plane perpendicular to the axis of cylindrical component 600 and a positioning portion 808 that locates an attachment portion 608 and/or one or more of the plurality of mounting surfaces (e.g., mounting surface 802, mounting surface 804, etc.) relative to the extension portion 806. In an exemplary embodiment, the positioning portion 808 of support portion 606 may locate an attachment portion 608 and/or one or more of the plurality of mounting surfaces (e.g., mounting surface 802, mounting surface 804, etc.) at an offset from the extension portion 806 as depicted in FIGS. 6-8. In an exemplary embodiment where accessory mount 602 is located adjacent to a bicycle stem component, an offset may allow for a centered location of an accessory that is attached to attachment portion 608. Although support portion 606 may have any suitable relative shape, in an exemplary embodiment, support portion 606 may be tapered as depicted in FIG. 6. Although support portion 606 may be constructed in any suitable manner (e.g., solid, partially hollowed, recessed, etc.), in an exemplary embodiment, support portion 606 may be recessed with a suitable wall thickness, for example, along the surface opposite the top side of attachment portion 608 and/or one or more of the plurality of mounting surfaces (e.g., mounting surface 802, mounting surface 804, etc.).

An engagement component 702 may be utilized to fix, lock, and/or adjust the engagement of engagement surface 610 to cylindrical component 600 as depicted in FIGS. 7-8. Exemplary engagement components may include one or more of bolts, screws, locks, levers, latches, hinges, magnets, clamps, adhesives, any other suitable engagement component, or any combination thereof. In an exemplary embodiment, accessory mount 602 may include an engagement cavity 810 that allows for a bolt to be used as an engagement component 702. Engagement cavity 810 may be recessed to allow a bolt to be fully recessed within accessory mount 602. Although accessory mount 602 may engage the threads of the bolt in any suitable manner, in an exemplary embodiment, a threaded insert (not depicted) may be inserted (e.g., with a press fit, adhesive, or in any other suitable manner) into accessory mount 602, such that an interior surface of the insert may engage the threads of the bolt. In some embodiments, e.g., as depicted in FIG. 7, the engagement cavity 810 may include a nut-shaped recess configured to fix the rotational orientation of a nut placed therein when engaging the threads of an engagement component such as a bolt. The tightening of the bolt may close opening 616 of accessory mount 602, as well as adjusting the frictional engagement of the engagement surface 610 of engagement portion 604 to cylindrical component 600.

Attachment portion 608 may be constructed in any suitable manner to facilitate simultaneous attachment of one or more accessories to accessory mount 602 via fixedly attaching the one or more accessory interfaces 618, such as via rotational attachment, slidable attachment, attachment via one or more bolts (e.g., bolts 704 and/or nuts 705), attachment via one or more bolts, attachment via one or more locks, attachment with one or more tabs, any other suitable attachment mechanism, or any combination thereof. In another non-limiting aspect, an exemplary attachment portion 608 can be configured such that one or more accessory interfaces 618 can be integrally formed with at least a portion of the attachment portion 608.

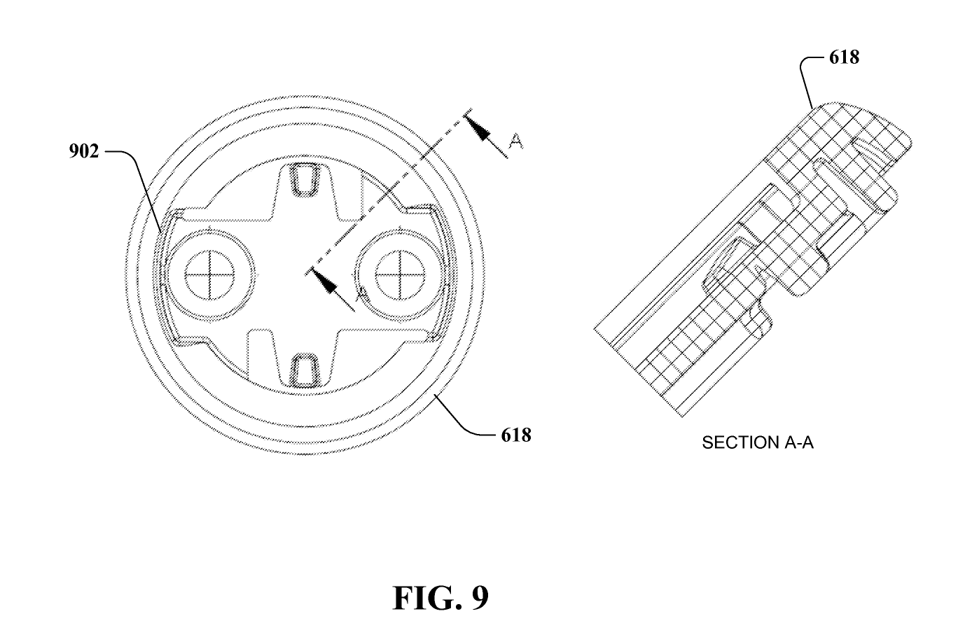

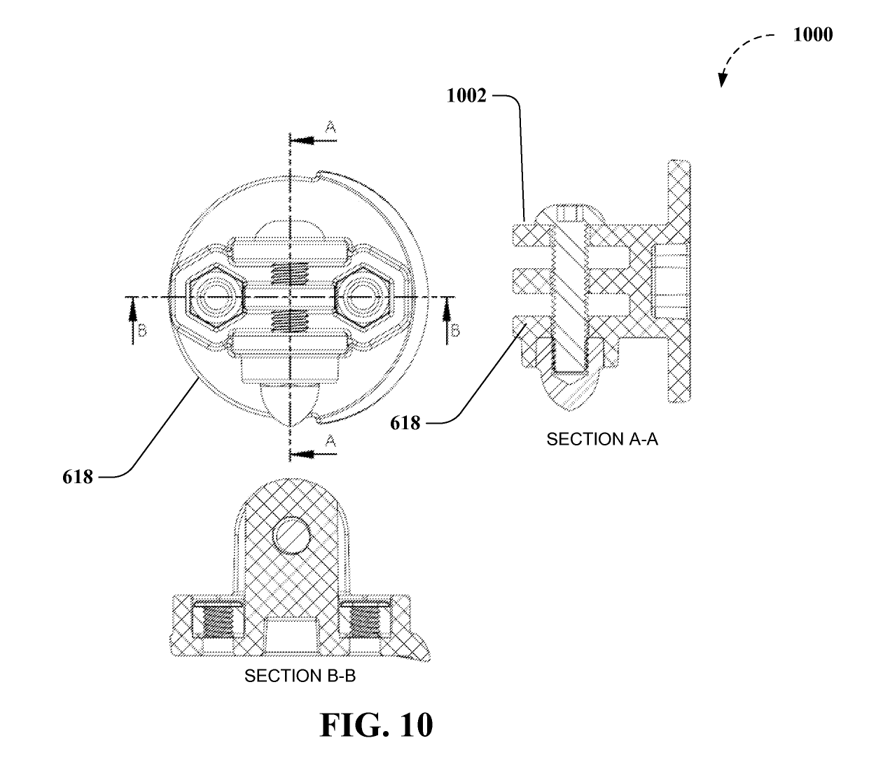

As a non-limiting example, FIG. 9 shows a top view and a section view of an exemplary accessory interface 618 according to various embodiments described herein. In a further non-limiting example, FIG. 10 shows a top view and section views of another exemplary accessory interface 618 according to various embodiments described herein. While an exemplary accessory interface 618 may include a compatible portion to attach to attachment portion 608 and/or one or more mounting surfaces (e.g., mounting surface 802, mounting surface 804, etc.), an exemplary accessory interface may attach to the accessory in any suitable manner, such as a sleeve, an adapter for an attachment component of the accessory, screws, bolts, clamps, adhesives, Velcro®, magnets, any other suitable attachment mechanism, or any combination thereof.

As described and depicted above for the exemplary embodiment of FIG. 9, an exemplary accessory interface 618, may include a compatible portion to fixedly attach to attachment portion 608 and/or one or more mounting surfaces (e.g., one or more of mounting surface 802, mounting surface 804, etc.), to facilitate attachment of accessories to accessory mount 602. As further described above regarding FIGS. 1-5, a compatible portion of an accessory or accessory interface may include one or more retaining tabs that slidably fit within attachment slots 902 of an exemplary accessory interface 618 as depicted in FIG. 9. In a further non-limiting aspect, as depicted in an exemplary embodiment of FIG. 10, an exemplary accessory interface 618 may include a compatible portion to fixedly attach to attachment portion 608 and/or one or more mounting surfaces (e.g., one or more of mounting surface 802, mounting surface 804, etc.), to facilitate attachment of accessories to accessory mount 602. For instance, in an exemplary embodiment of FIG. 10, an accessory interface 618 can comprise a hinged accessory mount 1002 configured to accept a compatible portion of an accessory and locate and/or position the accessory relative to attachment portion 608 and/or one or more mounting surfaces (e.g., one or more of mounting surface 802, mounting surface 804, etc.), as depicted in FIG. 6, for example.

It will also be understood that any suitable combination of attachment methods may be utilized. As a non-limiting example, in an illustrative embodiment an attachment portion 608 and/or one or more accessory interfaces 618, can be configured to fixedly attach the one or more accessory interfaces 618 in a variety of orientations and/or positions about the attachment portion 608 and relative to the cylindrical component 600 of a bicycle. For instance, as depicted with regard to FIGS. 6-10, attachment portion 608, one or more mounting surfaces (e.g., one or more of mounting surface 802, mounting surface 804, etc.), and/or one or more accessory interfaces 618 can be configured to fixedly attach the one or more accessory interfaces 618 in a selected one of a set of continuously variable orientations (e.g., no preset or predetermined orientations), about the attachment portion 608, and relative to the cylindrical component 600 of a bicycle, for example, as depicted regarding accessory interface 618 in FIG. 10 attached on mounting surface 804. In further non-limiting aspect, as further depicted with regard to FIGS. 6-10, attachment portion 608, one or more mounting surfaces (e.g., one or more of mounting surface 802, mounting surface 804, etc.), and/or one or more accessory interfaces 618 can be configured to fixedly attach the one or more accessory interfaces 618 in a fixed orientation or a subset of a set of fixed orientations determined by the configuration of the attachment portion 608, about the attachment portion 608, and relative to the cylindrical component 600 of a bicycle, for example, as depicted regarding accessory interface 618 in FIG. 9 attached on mounting surface 802.

Accordingly, in the exemplary embodiments depicted in FIGS. 6-8, accessory mount 602 can comprise a first accessory interface 618 of the plurality of accessory interfaces 618 configured to locate a first accessory of a plurality of accessories to a first position (e.g., one of mounting surface 802, mounting surface 804, etc.) of the attachment portion 608. In addition, accessory mount 602 can comprise a second accessory interface 618 of the plurality of accessory interfaces 618 configured to locate a second accessory of the plurality of accessories to a second position (e.g., another of mounting surface 802, mounting surface 804, etc.) of the attachment portion 608. As a non-limiting example, different accessories that can be located on the accessory mount 602 can comprise two or more of a bicycle computer, a speedometer, a global positioning system device, a music player, a telephone, a triathlon watch, a smart phone (as depicted in FIG. 6), a mobile transmitter, a wireless communication device, a camera (as depicted in FIG. 6), or a touch screen device. In an exemplary embodiment, a sleeve may substantially encase a smart phone, and may include a compatible portion to attach to attachment portion 608 and/or a compatible surface of an accessory interface. An exemplary smart phone can thus run any suitable program or “app” utilizing any suitable hardware and software of the smart phone.

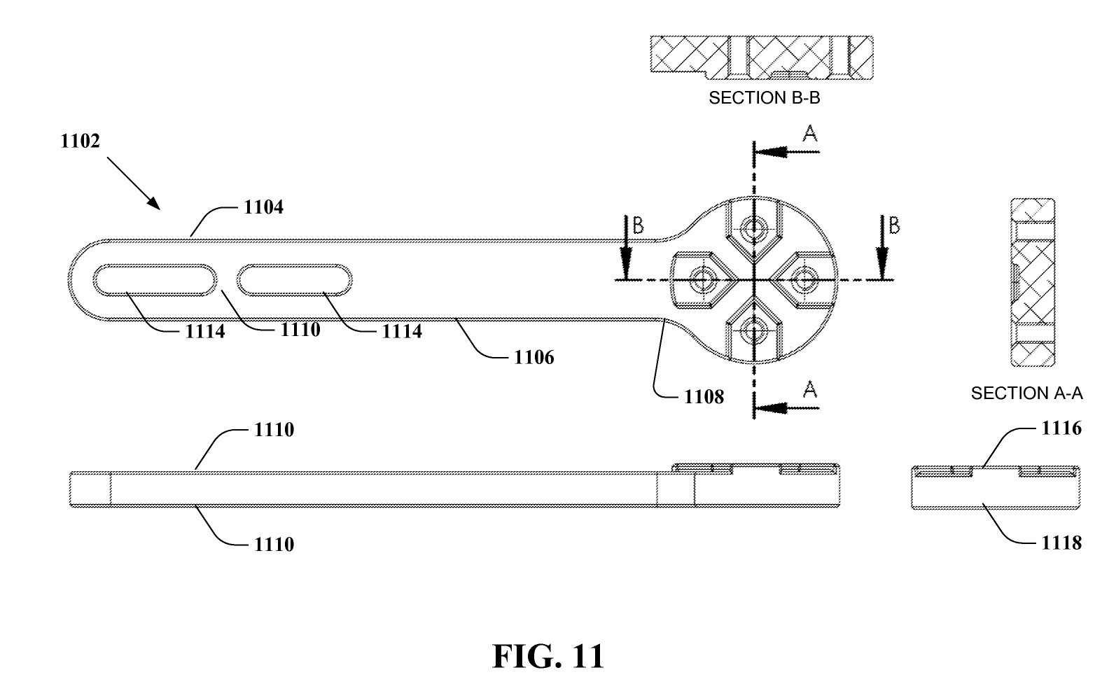

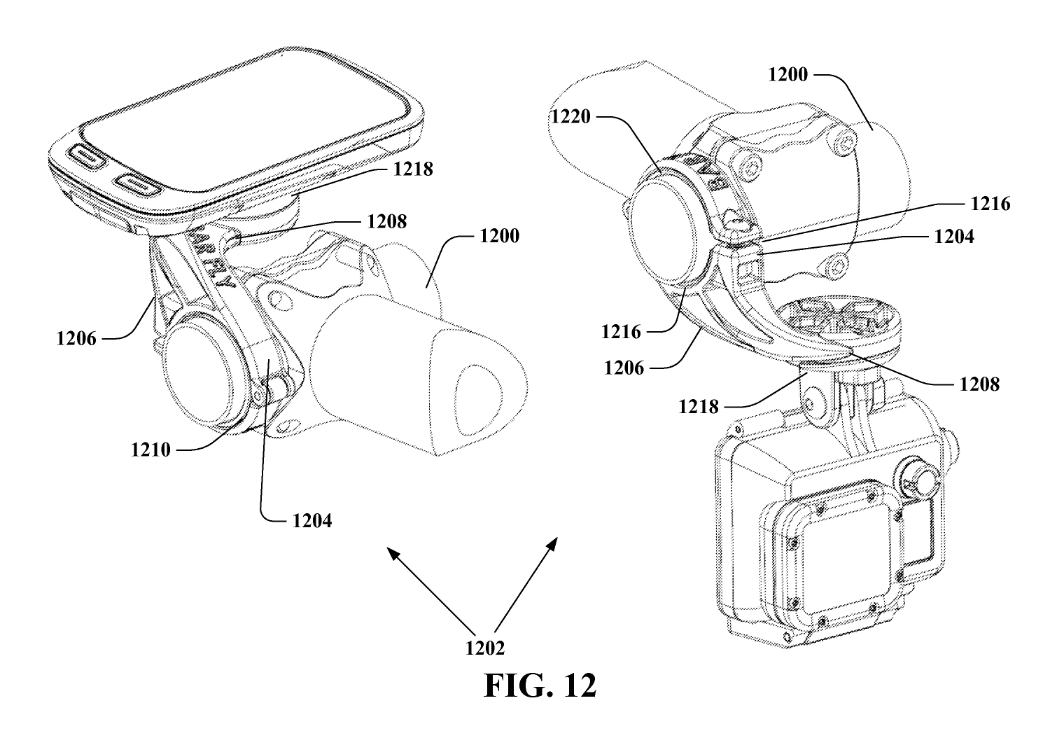

FIG. 11 depicts a top view, a front view, an end view, and a section view of another exemplary accessory mount 1102 in accordance with embodiments of the present disclosure. The accessory mount 1102 may include an engagement portion 1104, a support portion 1106, and an attachment portion 1108. In an exemplary embodiment, attachment portion 1108 facilitates fixedly attaching one or more accessory interfaces (e.g., accessory interfaces 618, accessory interfaces 1218, etc.), and can be coupled to support portion 1106 for attachment of one or more accessories to accessory mount 1102. In yet another embodiment, a plurality of different types of accessory interfaces (e.g., accessory interfaces 618, accessory interfaces 1218, etc.) may be fixedly attached to an attachment portion 1108 for attachment of two or more accessories to accessory mount 1102, for example, as described above regarding accessory mount 602 of FIGS. 6-10, and as described below regarding accessory mount 1202 of FIGS. 12-15. In another embodiment, a compatible surface of attachment portion 1108 may permit direct attachment of an accessory, as described herein.

In an exemplary embodiment of accessory mount 1102, each of engagement portion 1104, support portion 1106, and attachment portion 1108 may be constructed of two or more components in any suitable manner (not depicted). However, it will be understood that engagement portion 1104, support portion 1106, and attachment portion 1108 may comprise a unitary component, for example, as depicted in FIG. 11. It will be understood that accessory mount 1102 may include any additional suitable portions or components (not depicted), and that each of engagement portion 1104 and attachment portion 1108 may be coupled to support portion 1106 in any suitable manner, including with additional intervening portions or components.

Engagement portion 1104 may provide for engagement with a component (not depicted) of a bicycle or other surface where frictional engagement with a cylindrical component, for example, as described above regarding accessory mount 602 of FIGS. 6-10, and as described below regarding accessory mount 1202 of FIGS. 12-15, is not desirable or suitable. Thus, engagement portion 1104 can facilitate engagement with a component of a bicycle (not depicted) or other surface, where the component (not depicted) of a bicycle or other surface is characterized by a mounting location on the component (not depicted) of a bicycle or other surface having a complementary mounting portion. In a non-limiting example of a component (not depicted) of a bicycle or other surface having a complementary mounting portion, certain types of integrated bar-stem bicycle components can comprise a unitary handlebar and stem configuration and can be configured with a complementary mounting portion that can engage with engagement surfaces 1110 of engagement portion 1104. Engagement portion 1104, in an exemplary embodiment, can comprise an engagement component (e.g., complementary mounting slots 1114, etc.) that can accept another engagement component (e.g., threaded fasteners, etc.) for engagement of the engagement portion 1104 to the complementary mounting portion of the component of a bicycle (not depicted) or other surface.

Support portion 1106 may couple engagement portion 1104 to attachment portion 1108. Support portion 1106 may be constructed in any suitable manner to accommodate any suitable engagement portion 1104, attachment portion 1108, plurality of attachment portions 1108, any other suitable components or attachments, or any combination thereof. In an exemplary embodiment as depicted herein, a single engagement portion 1104 may be coupled to a single attachment portion 1108.

As with accessory mount 102, 602, etc. regarding FIGS. 1, 6, etc., accessory mount 1102 may be constructed of any suitable material or combination of materials, including metals (e.g., aluminum, magnesium), polymers, composites, ceramics, any other suitable material, or any combination thereof. In an exemplary embodiment, accessory mount 1102 can comprise an aluminum bar with one or more attachment portions 1108, for example, as described above regarding attachment portion 608 of FIGS. 6-10, and as described below regarding attachment portion 1208 of FIGS. 12-15.

In an exemplary embodiment a plurality of different types of accessory interfaces (e.g., accessory interfaces 618, accessory interfaces 1218, etc.) may be fixedly attached to an attachment portion 1108 for attachment of two or more accessories to accessory mount 1102. Accordingly, in this exemplary embodiment, attachment portion 1108 can comprise a plurality of mounting surfaces (e.g., mounting surface 1116, mounting surface 1118, etc.), wherein each of the plurality of mounting surfaces can be adapted to attach one or more of a plurality of accessory interfaces (e.g., accessory interfaces 618, accessory interfaces 1218, etc.). Thus, in a non-limiting aspect, an exemplary attachment portion 1108 can be configured for simultaneous attachment of a plurality of accessory interfaces (e.g., accessory interfaces 618, accessory interfaces 1218, etc.). As a result, in a further non-limiting aspect, a plurality of accessory interfaces (e.g., accessory interfaces 618, accessory interfaces 1218, etc.) can be configured for simultaneous attachment of one or more different accessories to the attachment portion 1108.

In an exemplary embodiment, two mounting surfaces (e.g., mounting surface 1116, mounting surface 1118, etc.) can be located on opposite sides of the attachment portion 1108. However, it will be understood that any suitable number of a plurality of mounting surfaces (e.g., mounting surface 1116, mounting surface 1118, etc.) can be located in any suitable manner relative to any number of sides of the attachment portion 1108 (not depicted).

An engagement component may be utilized to fix, lock, and/or adjust the engagement of engagement surface 1110 to the complementary mounting portion of the component of a bicycle (not depicted) or other surface. Exemplary engagement components may include one or more of bolts, screws, locks, levers, latches, hinges, magnets, clamps, adhesives, any other suitable engagement component, or any combination thereof. Engagement portion 1104, in an exemplary embodiment, can comprise an engagement component (e.g., complementary mounting slots 1114, etc.) that can accept another engagement component (e.g., threaded fasteners, etc.) for engagement of the engagement portion 1104 to the complementary mounting portion of the component of a bicycle (not depicted) or other surface. Although accessory mount 1102 may engage the complementary mounting portion of the component of a bicycle (not depicted) or other surface in any suitable manner, in an exemplary embodiment, a threaded insert (not depicted) may be inserted (e.g., with a press fit, adhesive, or in any other suitable manner) into the complementary mounting portion of the component of a bicycle (not depicted) or other surface, such that an interior surface of the insert may engage the threads of a threaded fastener (not depicted) inserted through complementary mounting slots 1114. Tightening of the threaded fastener can facilitate adjusting the engagement of the engagement surface 1110 of engagement portion 1104 to the complementary mounting portion of the component of a bicycle (not depicted) or other surface.

As described above regarding FIGS. 9-10, an exemplary accessory interface, such as one or more accessory interface 618, may include a compatible portion to attach to attachment portion 1108 and/or one or more mounting surfaces (e.g., mounting surface 1116, mounting surface 1118, etc.). An exemplary accessory interface, such as one or more accessory interface 618, may attach to the accessory in any suitable manner, such as a sleeve, an adapter for an attachment component of the accessory, screws, bolts, clamps, adhesives, Velcro®, magnets, any other suitable attachment mechanism, or any combination thereof. In an exemplary embodiment, a sleeve may substantially encase a smart phone, and may include a compatible portion to attach to attachment portion 1108 and/or one a compatible portion of an accessory interface attached to attachment portion 1108.

In addition, as depicted in an exemplary embodiment of FIG. 9, an exemplary accessory interface 618 may include a compatible portion to fixedly attach to attachment portion 1108 and/or one or more mounting surfaces (e.g., one or more of mounting surface 1116, mounting surface 1118, etc.), to facilitate attachment of accessories to accessory mount 1102. As further described above regarding FIGS. 1-5, in some embodiments, a compatible portion of an accessory or accessory interface may include one or more retaining tabs that slidably fit within attachment slots 902 of an exemplary accessory interface 618 as depicted in FIG. 9. In a further non-limiting aspect, as depicted in an exemplary embodiment of FIG. 10, an exemplary accessory interface 618 may include a compatible portion to fixedly attach to attachment portion 1108 and/or one or more mounting surfaces (e.g., one or more of mounting surface 1116, mounting surface 1118, etc.), to facilitate attachment of accessories to accessory mount 1102. For instance, in an exemplary embodiment of FIG. 10, an accessory interface 618 can comprise a hinged accessory mount 1002 configured to accept a compatible portion of an accessory and locate and/or position the accessory relative to attachment portion 1108 and/or one or more mounting surfaces (e.g., one or more of mounting surface 1116, mounting surface 1118, etc.).

It will also be understood that any suitable combination of attachment methods may be utilized. As a non-limiting example, in an illustrative embodiment an attachment portion 1108 and/or one or more accessory interfaces 618, can be configured to fixedly attach the one or more accessory interfaces 618 in a variety of orientations and/or positions about the attachment portion 1108 and relative to a component of a bicycle (not depicted) or other surface. For instance, as depicted with regard to FIGS. 9-11, attachment portion 1108, one or more mounting surfaces (e.g., one or more of mounting surface 1116, mounting surface 1118, etc.), and/or one or more accessory interfaces 618 can be configured to fixedly attach the one or more accessory interfaces 618 in a selected one of a set of continuously variable orientations (e.g., no preset or predetermined orientations), about the attachment portion 1108, and relative to a component of a bicycle (not depicted) or other surface, for example, as depicted regarding accessory interface 618 in FIG. 10 attached on mounting surface 1118. In further non-limiting aspect, as further depicted with regard to FIGS. 9-11, attachment portion 1108, one or more mounting surfaces (e.g., one or more of mounting surface 1116, mounting surface 1118, etc.), and/or one or more accessory interfaces 618 can be configured to fixedly attach the one or more accessory interfaces 618 in a fixed orientation or a subset of a set of fixed orientations determined by the configuration of the attachment portion 1108, about the attachment portion 1108, and relative to a component of a bicycle (not depicted) or other surface, for example, as depicted regarding accessory interface 618 in FIG. 9 attached on mounting surface 1116.

Accordingly, in the exemplary embodiments depicted in FIGS. 9-11, accessory mount 1102 can comprise a first accessory interface 618 of the plurality of accessory interfaces 618 configured to locate a first accessory of a plurality of accessories relative to a first position (e.g., one of mounting surface 1116, mounting surface 1118, etc.) of the attachment portion 1108. In addition, accessory mount 1102 can comprise a second accessory interface 618 of the plurality of accessory interfaces 618 configured to locate a second accessory of the plurality of accessories to a second position (e.g., another of mounting surface 1116, mounting surface 1118, etc.) of the attachment portion 1108. As a non-limiting example, different accessories that can be located on the accessory mount 1102 can comprise two or more of a bicycle computer, a speedometer, a global positioning system device, a music player, a telephone, a triathlon watch, a smart phone, a mobile transmitter, a wireless communication device, a camera, or a touch screen device.

FIG. 12 shows perspective views of a further exemplary accessory mount 1202 attached to cylindrical components 1200 of a bicycle in accordance with still further embodiments of the present disclosure. The accessory mount 1202 may include an engagement portion 1204, a support portion 1206, and an attachment portion 1208. Although a single engagement portion 1204 is depicted, it will be understood that any suitable number of engagement portions 1204 may be used to engage the accessory mount 1202 to the cylindrical component 1200. For example, in an exemplary embodiment (not depicted), two or more engagement portions 1204 may be coupled to support portion 1206 and engaged with the cylindrical component 1200. Although a single attachment portion 1208 is depicted, it will be understood that any suitable number of attachment portions 1208 may be used to facilitate attaching accessories to the accessory mount 1202. For example, in an exemplary embodiment (not depicted), two or more attachment portions 1208 may be coupled to support portion 1206 for attachment of two or more accessories to accessory mount 1202. In another exemplary embodiment, attachment portion 1208 facilitates fixedly attaching two or more accessory interfaces 1218, and can be coupled to support portion 1206 for attachment of two or more accessories to accessory mount 1202. In yet another embodiment, a plurality of different types of accessory interfaces 1218 may be fixedly attached to an attachment portion 1208 for attachment of two or more accessories to accessory mount 1202.

In an exemplary embodiment, each of engagement portion 1204, support portion 1206, and attachment portion 1208 may be constructed of two or more components in any suitable manner as depicted in FIG. 12. However, it will be understood that engagement portion 1204, support portion 1206, and attachment portion 1208 may comprise a unitary component. It will be understood that accessory mount 1202 may include any additional suitable portions or components (not depicted), and that each of engagement portion 1204 and attachment portion 1208 may be coupled to support portion 1206 in any suitable manner, including with additional intervening portions or components.

As with accessory mounts 102 and 602 regarding FIGS. 1 and 6, accessory mount 1202 may be constructed of any suitable material or combination of materials, including metals (e.g., aluminum, magnesium), polymers, composites, ceramics, any other suitable material, or any combination thereof. In an exemplary embodiment, accessory mount 1202 may be constructed of an acetal polymer such as Delrin. Although it will be understood that any suitable material may be selected for any suitable application, an acetal polymer such as Delrin may provide a flexibility that allows an opening 1216 of engagement portion 1204 to be expanded to be flexibly pulled over cylindrical component 1200, may have properties that permit suitable frictional engagement with cylindrical component 1200, and may provide stability and robustness for supporting an accessory upon attachment portion 1208.

Engagement portion 1204 may provide for frictional engagement with cylindrical component 1200. Engagement portion 1204 may include an interior engagement surface 1210 that frictionally engages with cylindrical component 1200. The width of engagement portion 1204 may define a surface area of engagement surface 1210 that frictionally engages with cylindrical component 1200, and may be any suitable width to provide a degree of friction suitable for a particular application and a desired degree of frictional engagement. Although engagement portion 1204 may have any suitable thickness, in an exemplary embodiment, a thickness may be suitable to allow engagement portion 1204 to be flexibly pulled over cylindrical component 1200. In a non-limiting aspect, one or more engagement portions 1204 of the accessory mount 1202 can employ an eccentric spacer 1220 between engagement surface 1210 and the cylindrical component 1200 of a bicycle to position the accessory mount 1202 and frictionally engage the cylindrical component 1200 of the bicycle. It will be understood that an eccentric spacer such as eccentric spacer 1220 may be used with any of the embodiments described herein.

Support portion 1206 may couple engagement portion 1204 to attachment portion 1208. Support portion 1206 may be constructed in any suitable manner to accommodate any suitable engagement portion 1204, plurality of engagement portions 1204, attachment portion 1208, plurality of attachment portions 1208, any other suitable components or attachments, or any combination thereof. In an exemplary embodiment as depicted herein a single engagement portion 1204 may be coupled to a single attachment portion 1208. Although in FIG. 12 the accessory mount is positioned such that support portion 1206 extends outward from the bicycle stem to position the accessory mount 1202 in front of the stem, it will be understood that the accessory mount 1202 may be rotated such that the attachment portion 1208 is situated over the bicycle stem, for example, by locating the engagement portion 1204 such that the support portion 1206 extends inward and over the bicycle stem.

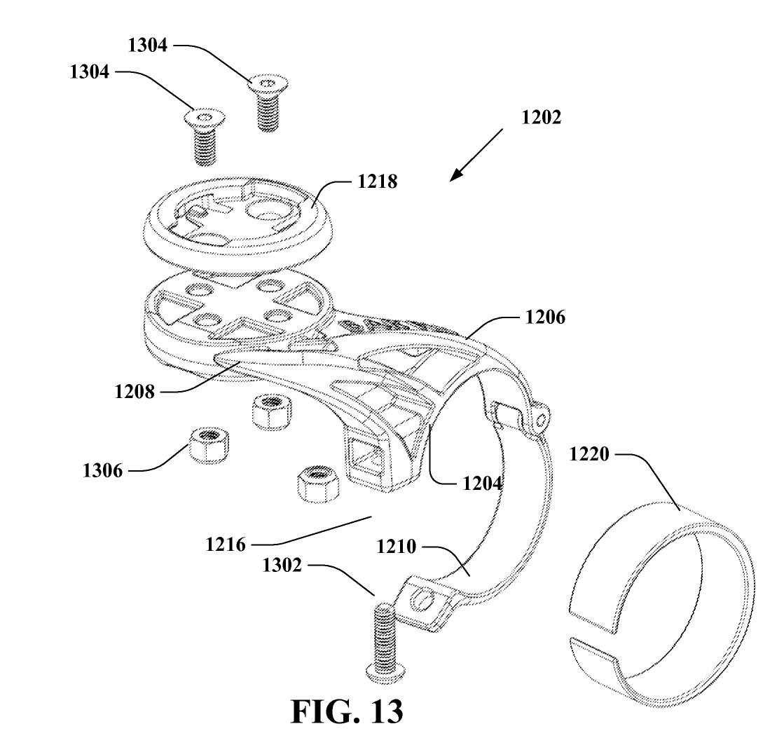

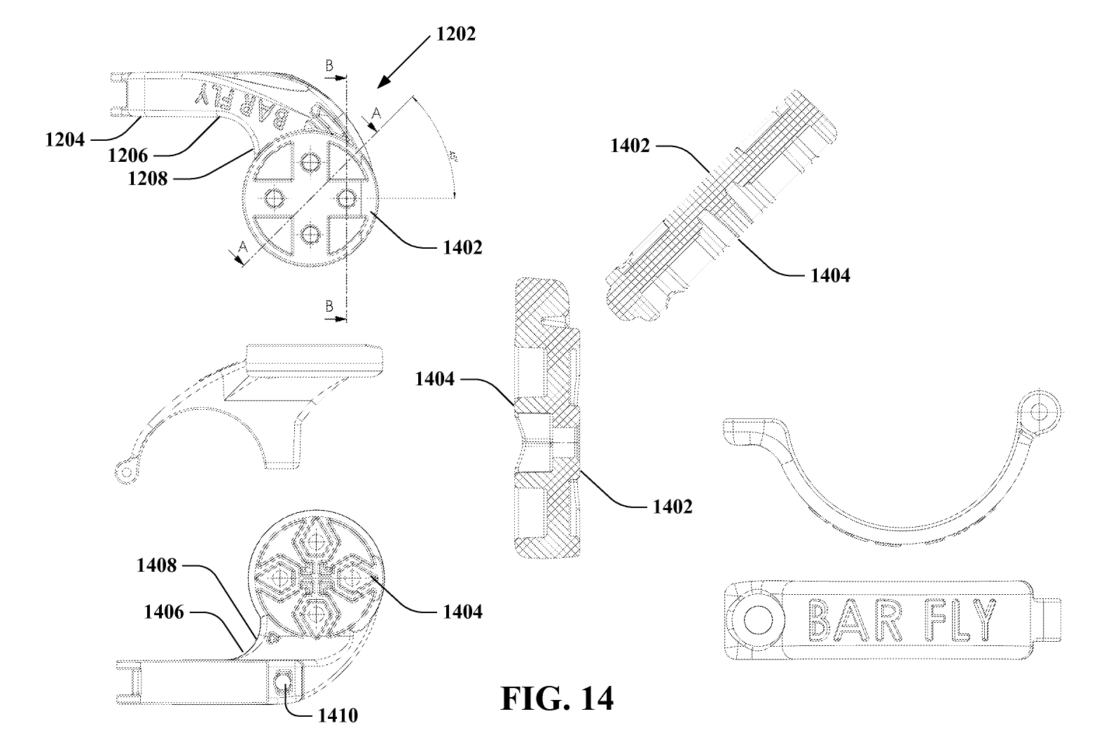

FIG. 13 depicts an exploded view of an exemplary accessory mount 1202 and accessory interface 1218 in accordance with embodiments of the present disclosure. FIG. 14 shows a top view, a side view, a bottom view, and section views according to non-limiting aspects of the present disclosure. One or more accessory interfaces 1218 may be fixedly attached to an attachment portion 1208 for attachment of one or more accessories to accessory mount 1202. Accordingly, in the exemplary embodiments of FIGS. 12-14, attachment portion 1208 can comprise a single mounting surface or a plurality of mounting surfaces (e.g., mounting surface 1402, mounting surface 1404, etc.), wherein each of the plurality of mounting surfaces can be adapted to attach one or more of a plurality of accessory interfaces 1218. Thus, in a non-limiting aspect, an exemplary attachment portion 1208 can be configured for simultaneous attachment of a plurality of accessory interfaces 1218. As a result, in a further non-limiting aspect, a plurality of accessory interfaces 1218 can be configured for simultaneous attachment of one or more different accessories to the attachment portion 1208.

In an exemplary embodiment, for example, two of the plurality of mounting surfaces (e.g., mounting surface 1402, mounting surface 1404, etc.) can be located on opposite sides of the attachment portion 1208. However, it will be understood that any suitable number of the plurality of mounting surfaces (e.g., mounting surface 1402, mounting surface 1404, etc.) can be located in any suitable manner relative to any number of sides of the attachment portion 1208 (not depicted).

In addition, although the engagement portion 1204, support portion 1206, and attachment portion 1208 may be configured in any suitable manner to define any suitable relative position of attachment portion 1208 to engagement portion 1204, in an exemplary embodiment, the attachment portion 1208 and/or one or more of the plurality of mounting surfaces (e.g., mounting surface 1402, mounting surface 1404, etc.) may be positioned such that a plane defined by at least one of the plurality of mounting surfaces is offset from the cylindrical component 1200. For example, if accessory mount 1202 is attached to bicycle handlebars, an accessory attached to accessory mount 1202 may be located in front of the bicycle handlebars and vertically offset above or below the handlebars, for ease of viewing and/or access. In other exemplary embodiments, attachment portion 1208 may be positioned in a manner such that the attachment portion 1208 and/or one or more of the plurality of mounting surfaces (e.g., mounting surface 1402, mounting surface 1404, etc.) may be positioned such that a plane defined by at least one of the plurality of mounting surfaces is substantially perpendicular to the axis of cylindrical component 1200, in a manner such an attachment portion 1208 and/or one or more of the plurality of mounting surfaces (e.g., mounting surface 1402, mounting surface 1404, etc.) is on a plane that is substantially aligned with the axis of cylindrical component 1200, or in any other suitable manner that defines a desired relationship between a plane corresponding to an attachment portion 1208 and/or one or more of the plurality of mounting surfaces (e.g., mounting surface 1402, mounting surface 1404, etc.) and cylindrical component 1200.

In the exemplary embodiments depicted in FIGS. 12-14, support portion 1206 may include an extension portion 1406 that extends along a plane perpendicular to the axis of cylindrical component 1200 and a positioning portion 1408 that locates an attachment portion 1208 and/or one or more of the plurality of mounting surfaces (e.g., mounting surface 1402, mounting surface 1404, etc.) relative to the extension portion 1406. In an exemplary embodiment, the positioning portion 1408 of support portion 1206 may locate an attachment portion 1208 and/or one or more of the plurality of mounting surfaces (e.g., mounting surface 1402, mounting surface 1404, etc.) at both a vertical offset and a horizontal offset from the extension portion 1406 as depicted in FIGS. 12-14. In an exemplary embodiment where accessory mount 1202 is located adjacent to a bicycle stem component, an offset may allow for a horizontally centered and vertically offset location of an accessory that is attached to attachment portion 1208. Although support portion 1206 may have any suitable relative shape, in an exemplary embodiment, support portion 1206 may be tapered as depicted in FIG. 12. Although support portion 1206 may be constructed in any suitable manner (e.g., solid, partially hollowed, recessed, etc.), in an exemplary embodiment, support portion 1206 may be recessed with a suitable wall thickness, for example, along the surface opposite attachment portion 1208 and/or one or more of the plurality of mounting surfaces (e.g., mounting surface 1402, mounting surface 1404, etc.).

An engagement component 1302 may be utilized to fix, lock, and/or adjust the engagement of engagement surface 1210 to cylindrical component 1200 as depicted in FIGS. 13-14. Exemplary engagement components may include one or more of bolts, screws, locks, levers, latches, hinges, magnets, clamps, adhesives, any other suitable engagement component, or any combination thereof. In an exemplary embodiment, accessory mount 1202 may include an engagement cavity 1410 that allows for a bolt to be used as an engagement component 1302. Engagement cavity 1410 may be recessed to allow a bolt to be fully recessed within accessory mount 1202. Although accessory mount 1202 may engage the threads of the bolt in any suitable manner, in an exemplary embodiment, a nut may be recessed and/or captured in engagement cavity 1410 (e.g., with a press fit, adhesive, or in any other suitable manner) into accessory mount 1202, such that threads of the nut engage the threads of the bolt. The tightening of the bolt may close opening 1216 of accessory mount 1202, as well as adjusting the frictional engagement of the engagement surface 1210 of engagement portion 1204 to cylindrical component 1200 and/or eccentric spacer 1220.

Attachment portion 1208 and/or one or more attachment portion 1208 may be constructed in any suitable manner to facilitate attachment of one or more accessories to accessory mount 1202 via fixedly attaching the one or more accessory interfaces 1218, such as via rotational attachment, slidable attachment, attachment via one or more bolts and/or nuts (e.g., bolts 1304 and/or nuts 1306), attachment via one or more bolts, attachment via one or more locks, attachment with one or more tabs, any other suitable attachment mechanism, or any combination thereof. Although some accessories may include an interface that is compatible with attachment portion 1208 of accessory mount 1202, in some embodiments an accessory interface, such as one or more accessory interface 1218, may be provided for accessories. In another non-limiting aspect, an exemplary attachment portion 1208 can be configured such that one or more accessory interfaces 1218 can be integrally formed with at least a portion of the attachment portion 1208.

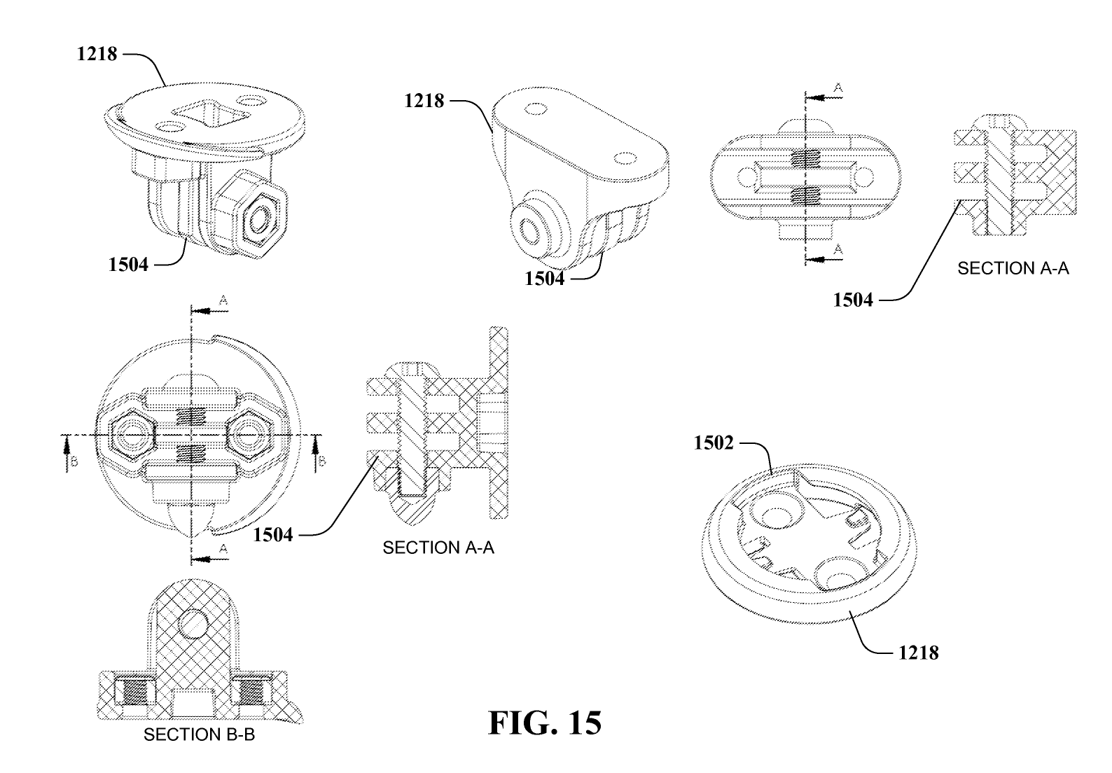

As a non-limiting example, FIG. 15 shows perspective and section views of exemplary accessory interfaces 1218 according to various embodiments described herein. While an exemplary accessory interface, such as one or more accessory interface 1218, may include a compatible portion to attach to attachment portion 1208 and/or one or more mounting surfaces (e.g., mounting surface 1402, mounting surface 1404, etc.), exemplary accessory interface, such as one or more accessory interface 1218, may attach to the accessory in any suitable manner, such as a sleeve, an adapter for an attachment component of the accessory, screws, bolts, clamps, adhesives, Velcro®, magnets, any other suitable attachment mechanism, or any combination thereof. As described above, attachment may be implemented in any suitable manner. Accordingly, as depicted in an exemplary embodiment of FIG. 15, an exemplary accessory interface 1218 may include a compatible portion to fixedly attach to attachment portion 1208 and/or one or more mounting surfaces (e.g., one or more of mounting surface 1402, mounting surface 1404, etc.), to facilitate attachment of accessories to accessory mount 1202. As further described above, a compatible portion of an accessory or accessory interface may include one or more retaining tabs that slidably fit within attachment slots 1502 of an exemplary accessory interface 1218 as depicted in FIG. 15. In a further non-limiting aspect, as depicted in an exemplary embodiment of FIG. 15, an exemplary accessory interface 1218 may include a compatible portion to fixedly attach to attachment portion 1208 and/or one or more mounting surfaces (e.g., one or more of mounting surface 1402, mounting surface 1404, etc.), to facilitate attachment of accessories to accessory mount 1202. For instance, in an exemplary embodiment of FIG. 15, an accessory interface 1218 can comprise a hinged accessory mount 1504 configured to accept a compatible portion of an accessory and locate and/or position the accessory relative to attachment portion 1208 and/or one or more mounting surfaces (e.g., one or more of mounting surface 1402, mounting surface 1404, etc.).

It will also be understood that any suitable combination of attachment methods may be utilized. As a non-limiting example, in an illustrative embodiment an attachment portion 1208 and/or one or more accessory interfaces 1218, can be configured to fixedly attach the one or more accessory interfaces 1218 in a variety of orientations and/or positions about the attachment portion 1208 and relative to the cylindrical component 1200 of a bicycle. For instance, as depicted with regard to FIGS. 12-15, attachment portion 1208, one or more mounting surfaces (e.g., one or more of mounting surface 1402, mounting surface 1404, etc.), and/or one or more accessory interfaces 1218 can be configured to fixedly attach the one or more accessory interfaces 1218 in a fixed orientation or a subset of a set of fixed orientations determined by the configuration of the attachment portion 1208, about the attachment portion 1208, and relative to the cylindrical component 1200 of a bicycle, for example, as depicted regarding accessory interfaces 1218 in FIG. 15 attached on one or more of mounting surface 1402, mounting surface 1404, etc.

Accordingly, in the exemplary embodiments depicted in FIGS. 12-14, accessory mount 1202 can comprise a first accessory interface 1218 configured to locate a first accessory of a plurality of accessories to a first position (e.g., one of mounting surface 1402, mounting surface 1404, etc.) of the attachment portion 1208 of attachment portion 1208. In addition, accessory mount 1202 can comprise a second accessory interface 1218 configured to locate a second accessory of the plurality of accessories to a second position (e.g., another of mounting surface 1402, mounting surface 1404, etc.) of the attachment portion 1208 of attachment portion 1208. As a non-limiting example, different accessories that can be located on the accessory mount 1202 can comprise two or more of a bicycle computer, a speedometer, a global positioning system device, a music player, a telephone, a triathlon watch, a smart phone (as depicted in FIG. 12), a mobile transmitter, a wireless communication device, a camera (as depicted in FIG. 12), or a touch screen device. In an exemplary embodiment, a sleeve may substantially encase a smart phone, and may include a compatible portion to attach to attachment portion 1208 and/or accessory interface 1218. An exemplary smart phone can thus run any suitable program or “app” utilizing any suitable hardware and software of the smart phone.

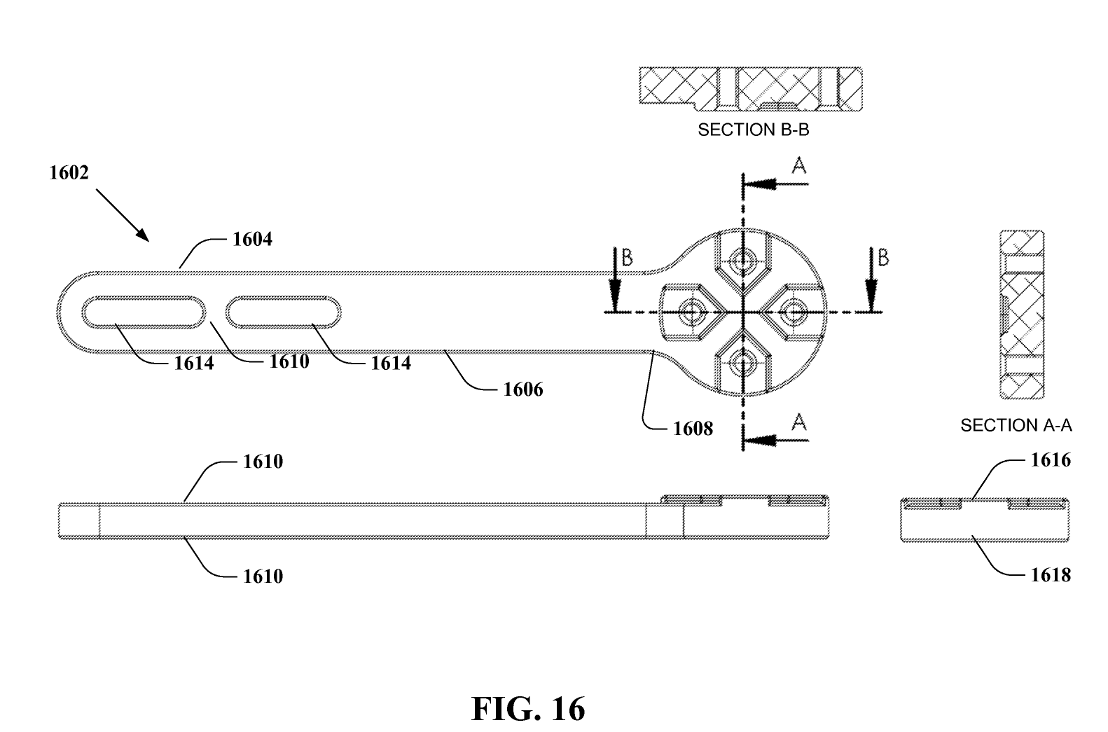

FIG. 16 depicts a top view, a front view, end view, and section views of another exemplary accessory mount 1602 in accordance with embodiments of the present disclosure. The accessory mount 1602 may include an engagement portion 1604, a support portion 1606, and an attachment portion 1608. In an exemplary embodiment, attachment portion 1608 can comprise, be affixed to, or be associated with, one or more attachment portions 1608 that facilitates fixedly attaching accessory interfaces (e.g., accessory interfaces 618, accessory interfaces 1218, etc.), and can be coupled to support portion 1606 for attachment of two or more accessories to accessory mount 1602. In yet another embodiment, a plurality of different types of accessory interfaces (e.g., accessory interfaces 618, accessory interfaces 1218, etc.) may be fixedly attached to an attachment portion 1608 for attachment of one or more accessories to accessory mount 1602, for example, as described above regarding accessory mount 602 of FIGS. 6-10, and as described above regarding accessory mount 1202 of FIGS. 12-15.

In an exemplary embodiment of accessory mount 1602, each of engagement portion 1604, support portion 1606, and attachment portion 1608 may be constructed of two or more components in any suitable manner (not depicted). However, it will be understood that engagement portion 1604, support portion 1606, and attachment portion 1608 may comprise a unitary component, for example, as depicted in FIG. 16. It will be understood that accessory mount 1602 may include any additional suitable portions or components (not depicted), and that each of engagement portion 1604 and attachment portion 1608 may be coupled to support portion 1606 in any suitable manner, including with additional intervening portions or components.

Similar to accessory mount 102 of FIG. 11, engagement portion 1604 may provide for engagement with a component (not depicted) of a bicycle or other surface where frictional engagement with a cylindrical component, for example, as described above regarding accessory mount 602 of FIGS. 6-10, and as described above regarding accessory mount 1202 of FIGS. 12-15, is not desirable or suitable. Thus, engagement portion 1604 can facilitate engagement with a component of a bicycle (not depicted) or other surface, where the component (not depicted) of a bicycle or other surface is characterized by a mounting location on the component (not depicted) of a bicycle or other surface having a complementary mounting portion. In a non-limiting example of a component (not depicted) of a bicycle or other surface having a complementary mounting portion, certain types of integrated bar-stem bicycle components can comprise a unitary handlebar and stem configuration and can be configured with a complementary mounting portion that can engage with engagement surfaces 1610 of engagement portion 1604. Engagement portion 1604, in an exemplary embodiment, can comprise an engagement component (e.g., complementary mounting slots 1614, etc.) that can accept another engagement component (e.g., threaded fasteners, etc.) for engagement of the engagement portion 1604 to the complementary mounting portion of the component of a bicycle (not depicted) or other surface.

Support portion 1606 may couple engagement portion 1604 to attachment portion 1608. Support portion 1606 may be constructed in any suitable manner to accommodate any suitable engagement portion 1604, attachment portion 1608, plurality of attachment portions 1608, any other suitable components or attachments, or any combination thereof. In an exemplary embodiment as depicted herein, a single engagement portion 1604 may be coupled to a single attachment portion 1608.

As with accessory mount 102, 602, 1102, etc. regarding FIGS. 1, 6, 11, etc., accessory mount 1602 may be constructed of any suitable material or combination of materials, including metals (e.g., aluminum, magnesium), polymers, composites, ceramics, any other suitable material, or any combination thereof. In an exemplary embodiment, accessory mount 1602 can comprise an aluminum bar with one or more attachment portions 1608.

In an exemplary embodiment as described herein, one or more accessory interfaces (e.g., accessory interfaces 618, accessory interfaces 1218, etc.) may be fixedly attached to an attachment portion 1608 for attachment of one or more accessories to accessory mount 1602. Accordingly, in the exemplary embodiments of FIG. 16, attachment portion 1608 can comprise one or more mounting surfaces (e.g., mounting surface 1616, mounting surface 1618, etc.), wherein each of the mounting surfaces can be adapted to attach one or more of a plurality of accessory interfaces (e.g., accessory interfaces 618, accessory interfaces 1218, etc.). Thus, in a non-limiting aspect, an exemplary attachment portion 1602 can be configured for simultaneous attachment of one or more of a plurality of accessory interfaces (e.g., accessory interfaces 618, accessory interfaces 1218, etc.), for example. As a result, in a further non-limiting aspect, a plurality of accessory interfaces (e.g., accessory interfaces 618, accessory interfaces 1218, etc.) can be configured for simultaneous attachment of one or more different accessories to the attachment portion 1608.

In an exemplary embodiment, for example, two of the plurality of mounting surfaces (e.g., mounting surface 1616, mounting surface 1618, etc.) can be located on opposite sides of the attachment portion 1608. However, it will be understood that any suitable number of the plurality of mounting surfaces (e.g., mounting surface 1616, mounting surface 1618, etc.) can be located in any suitable manner relative to any number of sides of the attachment portion 1608 (not depicted).

An engagement component may be utilized to fix, lock, and/or adjust the engagement of engagement surface 1610 to the complementary mounting portion of the component of a bicycle (not depicted) or other surface. Exemplary engagement components may include one or more of bolts, screws, locks, levers, latches, hinges, magnets, clamps, adhesives, any other suitable engagement component, or any combination thereof. Engagement portion 1604, in an exemplary embodiment, can comprise an engagement component (e.g., complementary mounting slots 1614, etc.) that can accept another engagement component (e.g., threaded fasteners, etc.) for engagement of the engagement portion 1604 to the complementary mounting portion of the component of a bicycle (not depicted) or other surface. Although accessory mount 1602 may engage the complementary mounting portion of the component of a bicycle (not depicted) or other surface in any suitable manner, in an exemplary embodiment, a threaded insert (not depicted) may be inserted (e.g., with a press fit, adhesive, or in any other suitable manner) into the complementary mounting portion of the component of a bicycle (not depicted) or other surface, such that an interior surface of the insert may engage the threads of a threaded fastener (not depicted) inserted through complementary mounting slots 1614. Tightening of the threaded fastener can facilitate adjusting the engagement of the engagement surface 1610 of engagement portion 1604 to the complementary mounting portion of the component of a bicycle (not depicted) or other surface.

As described above, an exemplary accessory interface, such as one or more accessory interface 1218, may include a compatible portion to attach to attachment portion 1608 and/or one or more mounting surfaces (e.g., mounting surface 1616, mounting surface 1618, etc.). An exemplary accessory interface, such as one or more accessory interface 1218, may attach to the accessory in any suitable manner, such as a sleeve, an adapter for an attachment component of the accessory, screws, bolts, clamps, adhesives, Velcro®, magnets, any other suitable attachment mechanism, or any combination thereof.

In addition, an exemplary accessory interface 1218 may include a compatible portion to fixedly attach to attachment portion 1608 and/or one or more mounting surfaces (e.g., one or more of mounting surface 1616, mounting surface 1618, etc.), to facilitate attachment of accessories to accessory mount 1602. As further described above, a compatible portion of an accessory or accessory interface may include one or more retaining tabs that slidably fit within attachment slots 1502 of an exemplary accessory interface 1218 as depicted in FIG. 15. In a further non-limiting aspect, as depicted in an exemplary embodiment of FIG. 10, an exemplary accessory interface 1218 may include a compatible portion to fixedly attach to attachment portion 1608 and/or one or more mounting surfaces (e.g., one or more of mounting surface 1616, mounting surface 1618, etc.), to facilitate attachment of accessories to accessory mount 1602. For instance, in an exemplary embodiment of FIG. 15, an accessory interface 1218 can comprise a hinged accessory mount 1504 configured to accept a compatible portion of an accessory and locate and/or position the accessory relative to attachment portion 1608 and/or one or more mounting surfaces (e.g., one or more of mounting surface 1616, mounting surface 1618, etc.), as depicted in FIG. 16, for example.

It will also be understood that any suitable combination of attachment methods may be utilized. As a non-limiting example, in an illustrative embodiment an attachment portion 1608 and/or one or more accessory interfaces 1218, can be configured to fixedly attach the one or more accessory interfaces 1218 in a variety of orientations and/or positions about the attachment portion 1608 and relative to a component of a bicycle (not depicted) or other surface. For instance, as depicted with regard to FIGS. 6-15, attachment portion 1608, one or more mounting surfaces (e.g., one or more of mounting surface 1616, mounting surface 1618, etc.), and/or one or more accessory interfaces 1218 can be configured to fixedly attach the one or more accessory interfaces 1218 in a selected one of a set of continuously variable orientations (e.g., no preset or predetermined orientations), about the attachment portion 1608, and relative to a component of a bicycle (not depicted) or other surface, for example, as depicted regarding accessory interface 1218 in FIG. 15 attached on mounting surface 1618. In further non-limiting aspect, as further depicted with regard to FIGS. 9-11 and 15, attachment portion 1608, one or more mounting surfaces (e.g., one or more of mounting surface 1616, mounting surface 1618, etc.), and/or one or more accessory interfaces 1218 can be configured to fixedly attach the one or more accessory interfaces 1218 in a fixed orientation or a subset of a set of fixed orientations determined by the configuration of the attachment portion 1608, about the attachment portion 1608, and relative to a component of a bicycle (not depicted) or other surface, for example, as depicted regarding accessory interface 1218 in FIG. 15 attached on mounting surface 1616.

Accordingly, in the exemplary embodiments depicted in FIGS. 15-16, accessory mount 1602 can comprise a first accessory interface 1218 of the plurality of accessory interfaces 1218 configured to locate a first accessory of a plurality of accessories to a first position (e.g., one of mounting surface 1616, mounting surface 1618, etc.) of the attachment portion 1608 of attachment portion 1608. In addition, accessory mount 1602 can comprise a second accessory interface 1218 of the plurality of accessory interfaces 1218 configured to locate a second accessory of the plurality of accessories to a second position (e.g., another of mounting surface 1616, mounting surface 1618, etc.) of the attachment portion 1608 of attachment portion 1608. As a non-limiting example, different accessories that can be located on the accessory mount 1602 can comprise two or more of a bicycle computer, a speedometer, a global positioning system device, a music player, a telephone, a triathlon watch, a smart phone, a mobile transmitter, a wireless communication device, a camera, or a touch screen device. In an exemplary embodiment, a sleeve may substantially encase a smart phone, and may include a compatible portion to attach to attachment portion 1608 and/or one or an accessory interface 1218.

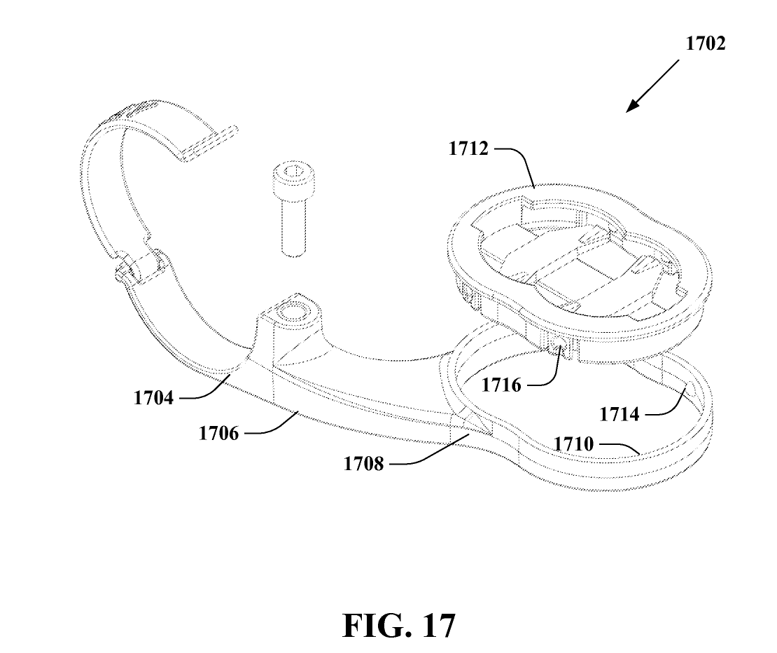

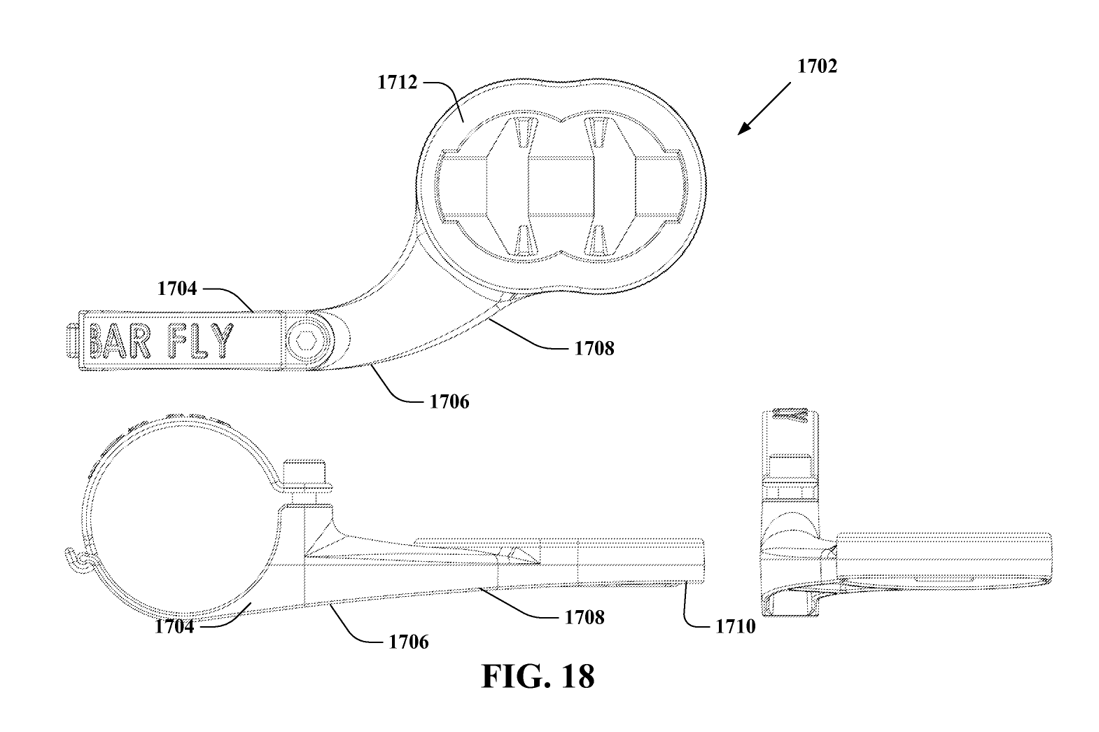

FIG. 17 shows a perspective view of another exemplary accessory mount 1702 attached in accordance with further embodiments of the present disclosure. FIG. 18 depicts a top view, a front view, and an end view of a further exemplary accessory mount 1702 in accordance with embodiments of the present disclosure. The accessory mount 1702 may include an engagement portion 1704, a support portion 1706, and an attachment portion 1708 having corresponding features and/or functionalities substantially as described above regarding engagement portions, support portions, and attachment portions of FIGS. 6, 12, etc.

In an exemplary embodiment, each of engagement portion 1704, support portion 1706, and attachment portion 1708 may be constructed of two or more components in any suitable manner as depicted in FIG. 17. However, it will be understood that engagement portion 1704, support portion 1706, and attachment portion 1708 may comprise a unitary component. It will be understood that accessory mount 1702 may include any additional suitable portions or components (not depicted), and that each of engagement portion 1704 and attachment portion 1708 may be coupled to support portion 1706 in any suitable manner, including with additional intervening portions or components.

In an exemplary embodiment as depicted herein, accessory mount 1702 may also include an insert mount portion 1710 coupled to attachment portion 1708 and configured to accept an insert adapter 1712. Alternatively, accessory mount 1702 may include an insert mount portion 1710 coupled to attachment portion 1708 and formed integrally with insert adapter 1712 or portions thereof. In an exemplary embodiment, as depicted herein, insert adapter 1712 can be configured to accept a particular accessory of a plurality of accessories, and can be further configured to engage with insert mount portion 1710.

In a non-limiting aspect, insert mount portion 1710 may comprise a plurality of latching surfaces 1714 configured to latch the insert adapter 1712 at a corresponding plurality of latching mechanisms 1716 of the insert adapter 1712. In a further non-limiting aspect, upon insertion of the insert adapter 1712 into the insert mount portion 1710 of accessory mount 1702, latching mechanisms 1716 of the insert adapter 1712 can align with the corresponding plurality of latching surfaces 1714 of insert mount portion 1710. Upon insertion of the particular accessory (not depicted) associated with the insert adapter 1712, one or more surfaces of the particular accessory positions one or more of the plurality of latching mechanisms 1716 of the insert adapter 1712 to a latching position, thereby engaging one or more of the plurality of latching surfaces 1714 of the insert mount portion 1710.

As a result, the engaging of the one or more of the plurality of latching mechanisms 1716 with the one or more of the plurality of latching surfaces 1714 of the insert mount portion 1710, upon insertion of the particular accessory (not depicted) associated with the insert adapter 1712 and the one or more surfaces of the particular accessory positioning the one or more of the plurality of latching mechanisms 1716 of the insert adapter 1712 to a latching position, removably secures the particular accessory (not depicted) and the insert adapter 1712 to the insert mount portion 1710 of the accessory mount 1702, until the particular accessory (not depicted) is removed from the insert adapter 1712. Alternatively, accessory mount 1702 including an insert mount portion 1710 coupled to attachment portion 1708 and formed integrally with insert adapter 1712 or portions thereof can facilitate removably securing the particular accessory (not depicted) without employing the one or more of the plurality of latching mechanisms 1716 and the one or more of the plurality of latching surfaces 1714 of the insert mount portion 1710.

As with accessory mount 102, 602, 1102, 1202, 1602, etc. regarding FIGS. 1, 6, 11, 12, 16, etc. accessory mount 1702 may be constructed of any suitable material or combination of materials, including metals (e.g., aluminum, magnesium), polymers, composites, ceramics, any other suitable material, or any combination thereof. In an exemplary embodiment, accessory mount 1702 may be constructed of an acetal polymer such as Delrin. Although it will be understood that any suitable material may be selected for any suitable application, an acetal polymer such as Delrin may provide a flexibility that allows an opening of a unitary engagement portion 1704 to be expanded to be flexibly pulled over a cylindrical component of a bicycle, may have properties that permit suitable frictional engagement with the cylindrical component of the bicycle, and may provide stability and robustness for supporting an accessory upon attachment portion 1708. Furthermore, while any suitable material may be selected for an insert adapter 1712 application, an acetal polymer such as Delrin may provide a flexibility that allows positioning the one or more of the plurality of latching mechanisms 1716 of the insert adapter 1712 to a latching position upon insertion of the particular accessory (not depicted) in the insert adapter 1712, may have properties that permit suitable engagement of insert adapter 1712 with insert mount portion 1710, and may provide stability and robustness for securing the particular accessory (not depicted) in the insert adapter 1712 upon insertion in insert mount portion 1710.

Insert adapter 1712 may attach to any of a plurality of accessories in any suitable manner, such as a sleeve, an adapter for an attachment component of the accessory, screws, bolts, clamps, adhesives, Velcro®, magnets, any other suitable attachment mechanism, or any combination thereof. In an exemplary embodiment as depicted in FIGS. 17-18, insert adapter 1712 may include a dual rotational attachment mechanism, that permits an accessory having a corresponding rotational attachment configuration as described above to be rotationally attached in one of a plurality of positions relative to the cylindrical component of the bicycle. In other embodiments (not depicted), a dual attachment mechanism may accommodate additional attachment mechanisms (e.g., slidable attachment, attachment via screws, attachment via bolts, attachment via locks, attachment with tabs, any other suitable attachment mechanism, or any combination thereof) in one of a plurality of positions relative to the cylindrical component of the bicycle. As a non-limiting example, different accessories that can be located on an appropriately configured insert adapter 1712 can comprise one or more of a bicycle computer, a speedometer, a global positioning system device, a music player, a telephone, a triathlon watch, a smart phone, a mobile transmitter, a wireless communication device, a camera, or a touch screen device.

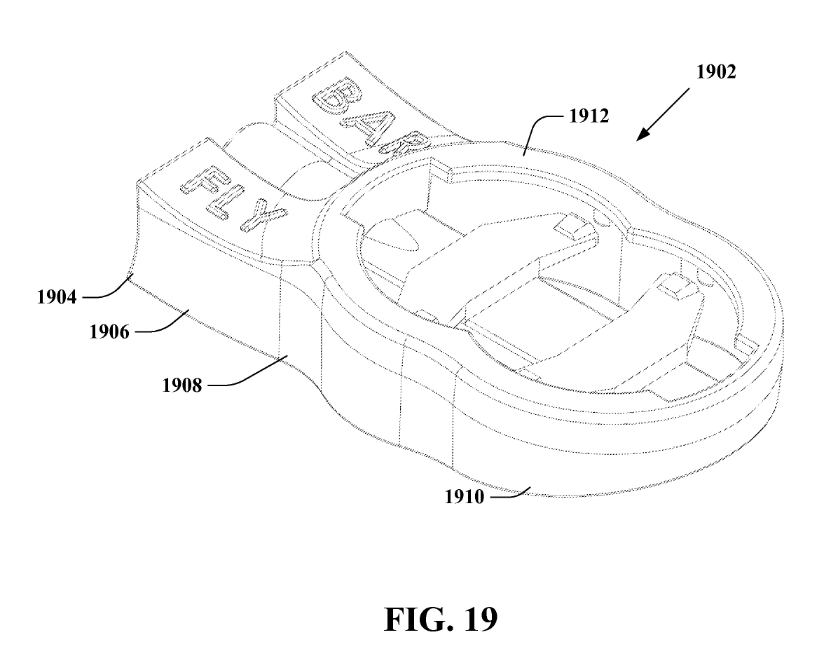

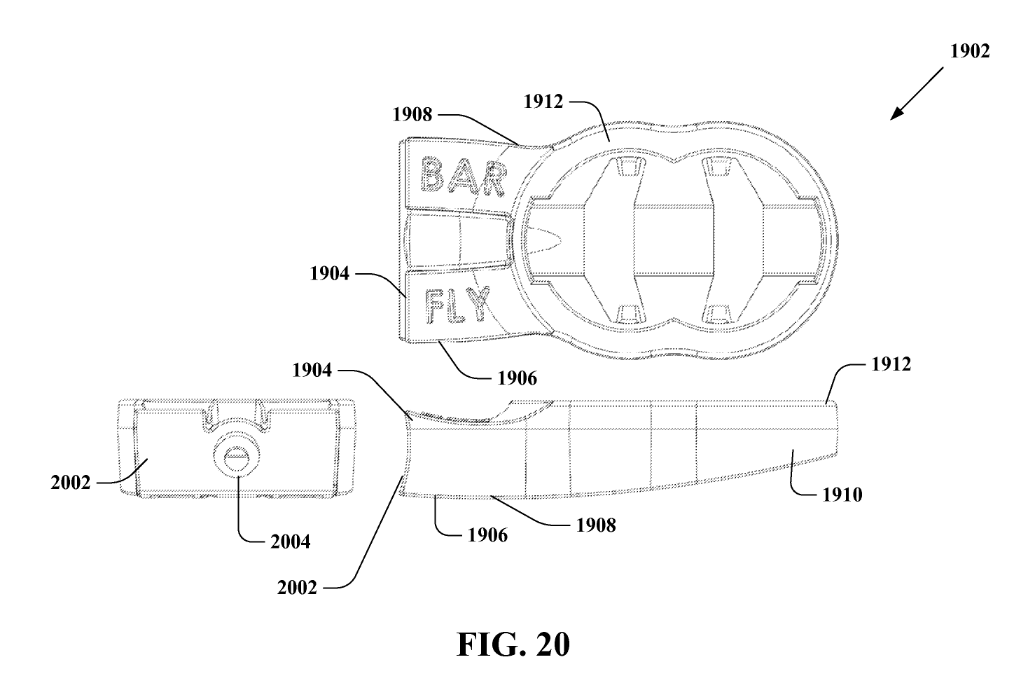

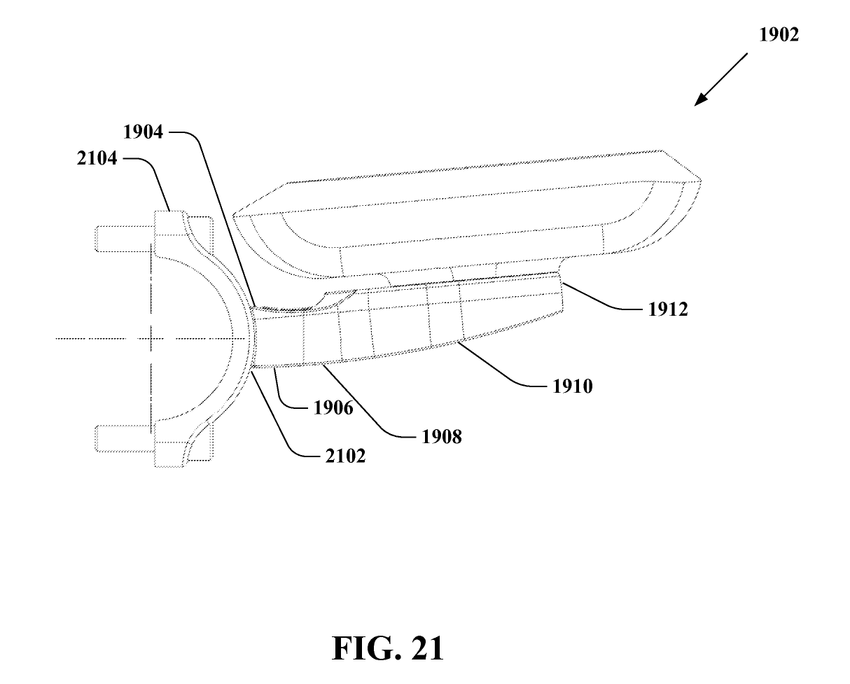

FIG. 19 shows a perspective view of another exemplary accessory mount 1902 attached in accordance with further embodiments of the present disclosure. The accessory mount 1902 may include an engagement portion 1904, a support portion 1906, and an attachment portion 1908 having corresponding features and/or functionalities substantially as described above regarding engagement portions, support portions, and attachment portions of FIGS. 6, 12, 17, etc., except for differences described below regarding engagement portion 1904 and FIGS. 20-21, for example.

In an exemplary embodiment, each of engagement portion 1904, support portion 1906, and attachment portion 1908 may be constructed of two or more components in any suitable manner as depicted in FIG. 19. However, it will be understood that engagement portion 1904, support portion 1906, and attachment portion 1908 may comprise a unitary component. It will be understood that accessory mount 1902 may include any additional suitable portions or components (not depicted), and that each of engagement portion 1904 and attachment portion 1908 may be coupled to support portion 1906 in any suitable manner, including with additional intervening portions or components.

In an exemplary embodiment as depicted herein, accessory mount 1902 may also include an insert mount portion 1910 coupled to attachment portion 1908 and configured to accept an insert adapter 1912, for example, as described above regarding FIG. 17. Alternatively, accessory mount 1902 may include an insert mount portion 1910 coupled to attachment portion 1908 and formed integrally with insert adapter 1912 or portions thereof. In an exemplary embodiment, as depicted herein, insert adapter 1912 can be configured to accept an accessory of a plurality of accessories in a plurality of positions, and can be further configured to engage with insert mount portion 1910.

As further described above regarding FIG. 17, in a non-limiting aspect, insert mount portion 1910 may comprise a plurality of latching surfaces (not depicted) configured to latch the insert adapter 1912 at a corresponding plurality of latching mechanisms (not depicted) of the insert adapter 1912. In a further non-limiting aspect, upon insertion of the insert adapter 1912 into the insert mount portion 1910 of accessory mount 1902, latching mechanisms (not depicted) of the insert adapter 1912 can align with the corresponding plurality of latching surfaces (not depicted) of insert mount portion 1910. Upon insertion of the particular accessory (not depicted) associated with the insert adapter 1912, one or more surfaces of the particular accessory positions one or more of the plurality of latching mechanisms (not depicted) of the insert adapter 1912 to a latching position, thereby engaging one or more of the plurality of latching surfaces (not depicted) of the insert mount portion 1910.

As a result, the engaging of the one or more of the plurality of latching mechanisms (not depicted) with the one or more of the plurality of latching surfaces (not depicted) of the insert mount portion 1910, upon insertion of the particular accessory (not depicted) associated with the insert adapter 1912 and the one or more surfaces of the particular accessory positioning the one or more of the plurality of latching mechanisms (not depicted) of the insert adapter 1912 to a latching position, removably secures the particular accessory (not depicted) and the insert adapter 1912 to the insert mount portion 1910 of the accessory mount 1902, until the particular accessory (not depicted) is removed from the insert adapter 1912. Alternatively, accessory mount 1902 including an insert mount portion 1910 coupled to attachment portion 1908 and formed integrally with insert adapter 1912 or portions thereof can facilitate removably securing the particular accessory (not depicted) without employing the one or more of the plurality of latching mechanisms (not depicted) with the one or more of the plurality of latching surfaces (not depicted) of the insert mount portion 1910.

As with accessory mount 102, 602, 1102, 1202, 1602, 1702, etc. regarding FIGS. 1, 6, 11, 12, 16-17, etc. accessory mount 1902 may be constructed of any suitable material or combination of materials, including metals (e.g., aluminum, magnesium), polymers, composites, ceramics, any other suitable material, or any combination thereof. In an exemplary embodiment, accessory mount 1902 may be constructed of an acetal polymer such as Delrin. As an example, although it will be understood that any suitable material may be selected for an insert adapter 1912 application, an acetal polymer such as Delrin may provide a flexibility that allows positioning the one or more of the plurality of latching mechanisms (not depicted) of the insert adapter 1912 to a latching position upon insertion of the particular accessory (not depicted) in the insert adapter 1912, may have properties that permit suitable engagement of insert adapter 1912 with insert mount portion 1910, and may provide stability and robustness for securing the particular accessory (not depicted) in the insert adapter 1912 upon insertion in insert mount portion 1910.

An exemplary accessory interface, such as insert adapter 1912, and so on may attach to any of a plurality of accessories in any suitable manner, such as a sleeve, an adapter for an attachment component of the accessory, screws, bolts, clamps, adhesives, Velcro®, magnets, any other suitable attachment mechanism, or any combination thereof. In an exemplary embodiment as depicted in FIGS. 17-18, insert adapter 1712 may include a dual rotational attachment mechanism, that permits an accessory having a corresponding rotational attachment configuration as described above to be rotationally attached in one of a plurality of positions relative to the cylindrical component of the bicycle. In other embodiments (not depicted), a dual attachment mechanism may accommodate additional attachment mechanisms (e.g., slidable attachment, attachment via screws, attachment via bolts, attachment via locks, attachment with tabs, any other suitable attachment mechanism, or any combination thereof) in one of a plurality of positions relative to the cylindrical component of the bicycle. As a non-limiting example, different accessories that can be located on an appropriately configured insert adapter 1912 can comprise one or more of a bicycle computer, a speedometer, a global positioning system device, a music player, a telephone, a triathlon watch, a smart phone, a mobile transmitter, a wireless communication device, a camera, or a touch screen device.

FIG. 20 depicts a top view, a front view, and an end view of exemplary accessory mount 1902 in accordance with embodiments of the present disclosure. FIG. 21 depicts a side view of an exemplary accessory mount 1902 according to non-limiting aspects of the present disclosure. In an exemplary embodiment as depicted herein, engagement portion 1904 can comprise one or more engagement surfaces 2002 configured to frictionally engage one or more complementary surfaces 2102 of a component 2104 of a bicycle. In an exemplary embodiment, engagement portion 1904 may comprise engagement surface 2002 that frictionally engages a complementary surface 2102 of a component 2104 comprising a stem of a bicycle. The dimensions of engagement portion 1904 may define a surface area of engagement surface 2002 that frictionally engages complementary surface 2102 of a component 2104, may be any suitable width to provide a degree of friction suitable for a particular application and a desired degree of frictional engagement, and may be configured to provide a desired degree of adjustability about the component 2104.

In another non-limiting embodiment, exemplary accessory mount 1902 can comprise an engagement component 2004. An engagement component 2004 may be utilized to fix, lock, and/or adjust the engagement of engagement surface 2002 to component 2104 of a bicycle as depicted in FIG. 21. Exemplary engagement components may include one or more of bolts, screws, locks, levers, latches, hinges, magnets, clamps, adhesives, any other suitable engagement component, or any combination thereof. In an exemplary embodiment, engagement portion of accessory mount 1902 and/or component 2104 of a bicycle may include an engagement cavity (not depicted) that allows for a bolt to be used as an engagement component 2004. Engagement cavity (not depicted) may be recessed to allow a bolt to be fully recessed within engagement portion of accessory mount 1902 and/or component 2104 of a bicycle. Although accessory mount 1902 may engage the threads of the bolt in any suitable manner, in an exemplary embodiment, a threaded insert (not depicted) may be inserted (e.g., with a press fit, adhesive, or in any other suitable manner) into accessory mount 1902, such that an interior surface of the insert may engage the threads of the bolt. The tightening of the bolt may adjust the frictional engagement of the engagement surface 2002 of engagement portion 1904 to the complementary surface 2102 of a component 2104 comprising a stem of a bicycle.

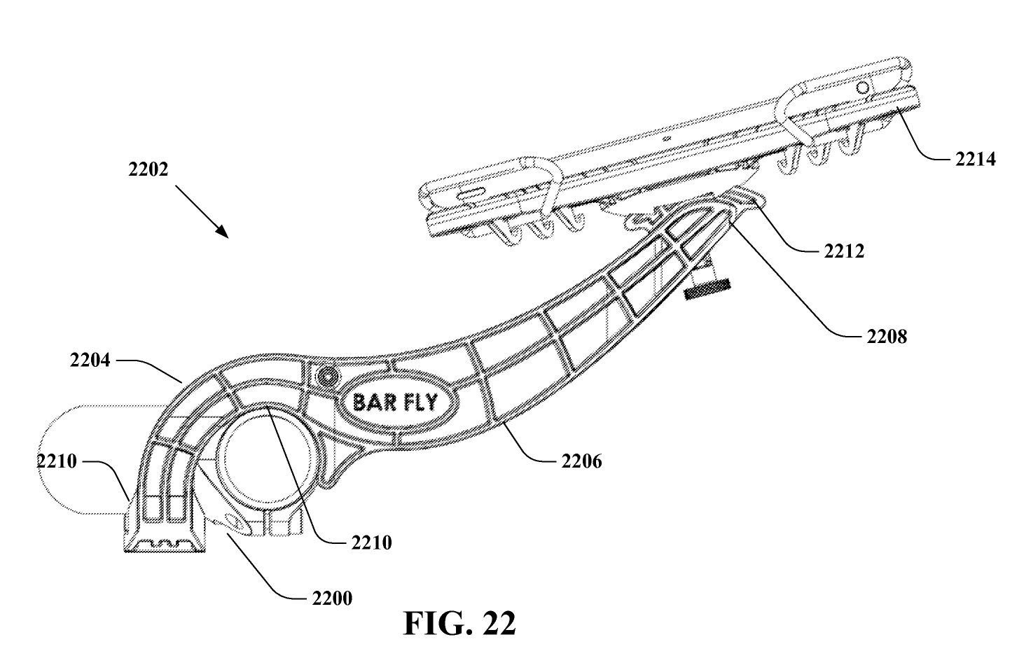

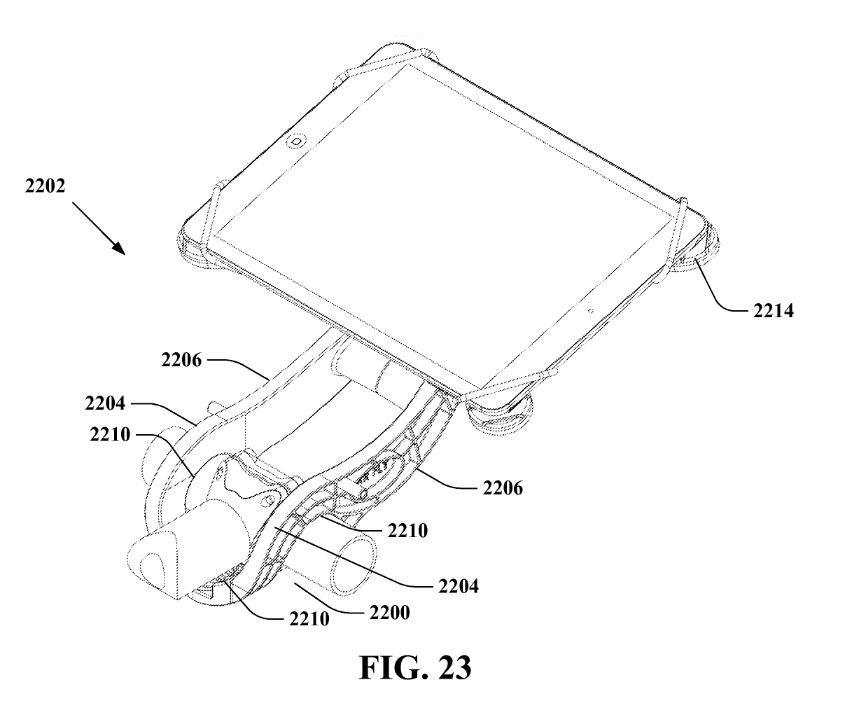

FIG. 22 depicts a side view of an exemplary cantilevered object mount 2200 for locating an object relative to a target area according to non-limiting aspects of the present disclosure. FIG. 23 shows a perspective view of an exemplary cantilevered object 2202 mount for locating an object relative to a target area 2200 in accordance with further embodiments of the present disclosure. The cantilevered object mount 2202 may include an engagement portion 2204, a support portion 2206, and an attachment portion 2208. Although an engagement portion 2204 comprising multiple components is depicted, it will be understood that any suitable number and/or configuration of engagement portions 2204 may be used to engage the cantilevered object mount 2202 to the complementary surfaces of a target area 2200. For example, in an exemplary embodiment (not depicted), one or more engagement portions 2204 may be coupled to support portion 2206 and engaged with the complementary surfaces of a target area 2200.

In a non-limiting aspect, an exemplary cantilevered object mount 2202 can facilitate locating an object relative to a target area of a bicycle such as relative to the stem and handlebars. Thus, an exemplary cantilevered object mount 2202 can comprise one or more engagement portions 2204 that define a plurality of engagement surfaces 2210 comprising, for example, a first surface adapted to rest underneath a stem of the bicycle and a second surface adapted to rest about a surface of a handlebar of the bicycle.

Although an attachment portion 2208 comprising multiple components is depicted, it will be understood that any suitable number and/or configuration of attachment portions 2208 may be used to facilitate attaching accessories to the cantilevered object mount 2202. For example, in an exemplary embodiment (not depicted), one or more attachment portions 2208 may be coupled to support portion 2206 for attachment of two or more accessories to cantilevered object mount 2202. In another exemplary embodiment, attachment portion 2208 can comprise, be affixed to, or be associated with, a mounting head 2212 that facilitates fixedly attaching a mounting platform 2214 to the cantilevered object mount, and can be coupled to support portion 2206 for attachment of accessories to cantilevered object mount 2202. In yet another embodiment, any of a number of different types of mounting platforms 2218 may be fixedly attached to a mounting head 2212 for attachment of accessories to cantilevered object mount 2202.

In an exemplary embodiment, each of engagement portion 2204, support portion 2206, and attachment portion 2208 may be constructed of two or more components in any suitable manner as depicted in FIG. 22. However, it will be understood that engagement portion 2204, support portion 2206, and attachment portion 2208 may comprise a unitary component. It will be understood that cantilevered object mount 2202 may include any additional suitable portions or components (not depicted), and that each of engagement portion 2204 and attachment portion 2208 may be coupled to support portion 2206 in any suitable manner, including with additional intervening portions or components.

As with accessory mounts 102, 602, 1202, etc., cantilevered object mount 2202 may be constructed of any suitable material or combination of materials, including metals (e.g., aluminum, magnesium), polymers, composites, ceramics, any other suitable material, or any combination thereof. In an exemplary embodiment, cantilevered object mount 2202 may be constructed of a polymer. Although it will be understood that any suitable material may be selected for any suitable application, a polymer may provide stability and robustness for supporting an accessory upon attachment portion 2208.

Engagement portion 2204 may provide for engagement with complementary surfaces of a target area 2200 and may include a plurality of engagement surfaces 2210 configured to rest against complementary surfaces of the target area 2200 and employ the weight of the cantilevered object mount 2202 to securely engage the cantilevered object mount 2202 on the target area 2200. The dimensions, shape, configuration, surface texture, and/or other properties of engagement portion 2204 may define a plurality of engagement surfaces 2210 that engage with complementary surfaces of a target area 2200, and may be any suitable dimension, shape, configuration, surface texture, etc., to facilitate employing the weight of the cantilevered object mount 2202 to securely engage the cantilevered object mount 2202 on the target area 2200 for a particular application and a desired degree of engagement. Although engagement portion 2204 may have any suitable thickness, in an exemplary embodiment, a thickness may be suitable to allow engagement portion 2204 to rest against complementary surfaces of the target area 2200 and stably support the weight of the cantilevered object mount 2202 and associated accessories.

Support portion 2206 may couple engagement portion 2204 to attachment portion 2208 and may be constructed in any suitable manner to accommodate any suitable engagement portion 2204, plurality of engagement portions 2204, attachment portion 2208, plurality of attachment portions 2208, mounting head 2212, mounting platform 2214, any other suitable components or attachments, or any combination thereof. In an exemplary embodiment as depicted herein, a single engagement portion 2204 comprising multiple components may be coupled to a single attachment portion 2208 comprising multiple components, as further described herein. Although support portion 2206 may be constructed in any suitable manner (e.g., solid, partially hollowed, recessed, etc.), in an exemplary embodiment, support portion 2206, or portions thereof, may be recessed with a suitable wall thickness, for example, along one or more surfaces between engagement portion 2204 and attachment portion 2208.

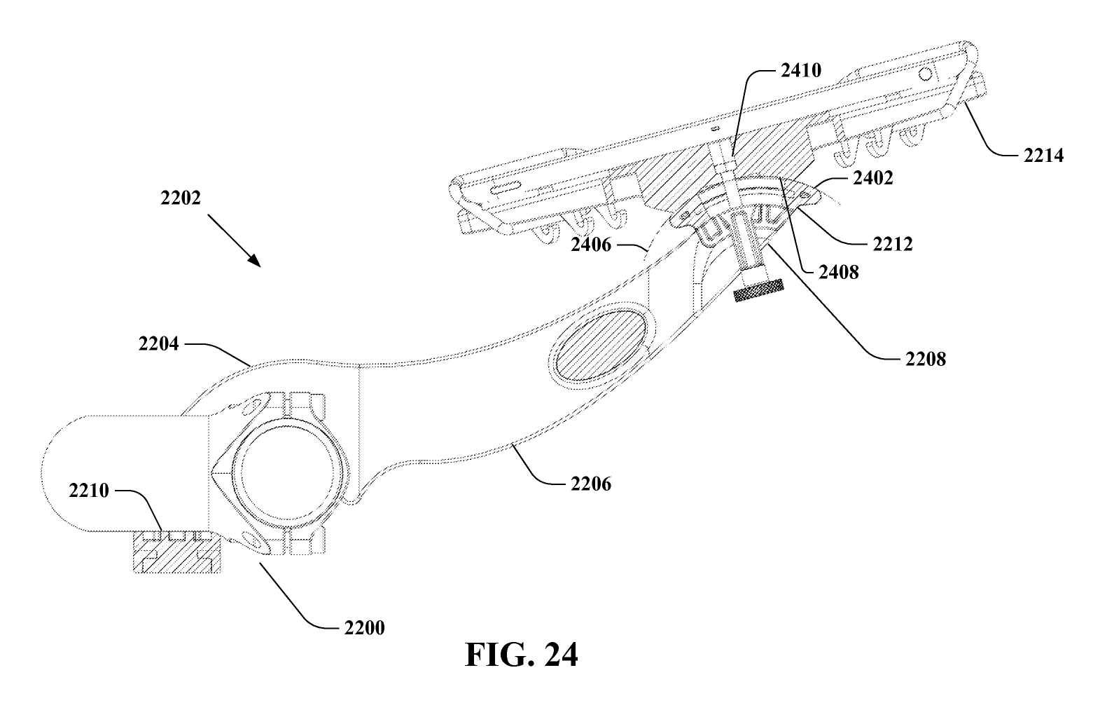

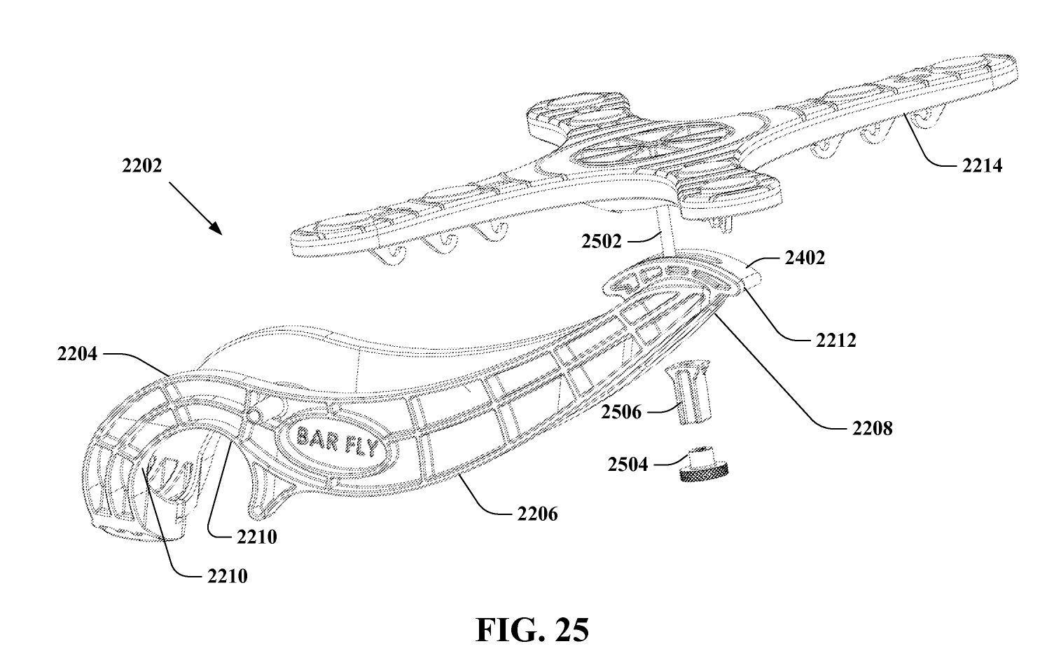

In a further embodiment, a mounting head 2212 can be configured to variably position the mounting platform 2214 and any associated accessory. For example, FIG. 24 shows a section view of an exemplary cantilevered object mount 2202 according to non-limiting aspects of the present disclosure. FIG. 25 depicts an exploded view of an exemplary cantilevered object mount 2202 according to further non-limiting aspects of the present disclosure. An exemplary mounting head 2212 can comprise a mounting surface 2402, defined by an arc 2406 about the attachment portion 2208. In an exemplary embodiment as depicted herein, mounting surface 2402 can engage a complementary surface 2408 of the mounting platform 2214, such that the arc 2406 is oriented to allow forward and aft rotation of the mounting platform 2214 about the mounting head 2212.

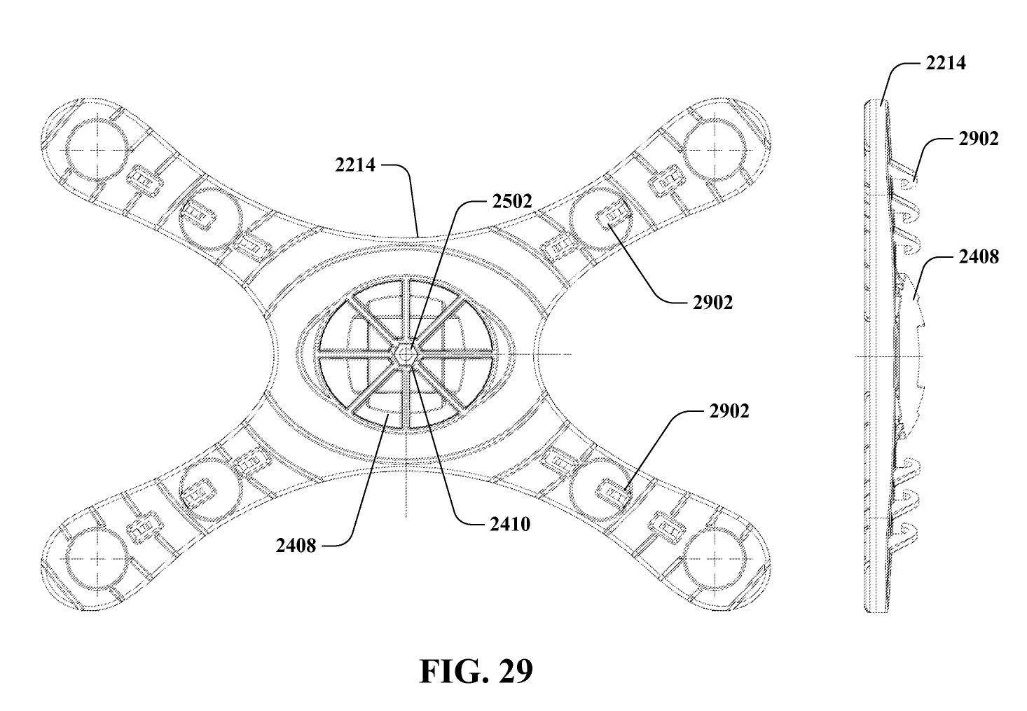

In an exemplary embodiment, a cantilevered object mount 2202 can further comprise a shaft 2502 that passes through the mounting head 2212 and the mounting surface 2402. In a non-limiting aspect, the shaft 2502 can facilitate removably securing the mounting platform 2214 to the mounting head 2212. As a non-limiting example, the shaft can comprise a bolt that secures to the mounting platform 2214 at a cavity 2410 in the mounting platform 2214 as further described herein regarding FIG. 29, for example. At the opposite end, an exemplary shaft 2502 comprising a bolt can be removably secured to the mounting head 2212 via a thumbscrew 2504 and standoff 2506, in a further non-limiting aspect. Accordingly, the mounting platform 2214 can be removably secured the to the mounting head 2212 by compression of the mounting surface 2402 of mounting head 2212 against the complementary surface 2408 of the mounting platform 2214 applied via the bolt the thumbscrew 2504 and the standoff 2506.

In an exemplary embodiment as depicted herein, a shaft 2502 can be oriented substantially orthogonal to a plane of the mounting platform 2214 that receives the object. Thus, in a further non-limiting aspect, the mounting surface 2402 of mounting head 2212 against the complementary surface 2408 of the mounting platform 2214 and the shaft that passes through the mounting surface 2402 facilitates removably securing the mounting platform 2214 to the mounting head 2212 and allows rotation of the mounting platform 2214 about an axis defined by the shaft, as can be seen in FIGS. 24-25 and 29. As a result, according to an exemplary embodiment of the cantilevered object mount 2202, the mounting head 2212 can be configured to variably position the mounting platform 2214 about two axes of rotation relative to the attachment portion 2208. In a non-limiting aspect, the mounting platform 2214 can be variably positioned in a forward and aft rotation of the mounting platform 2214 about the mounting head 2212 as well as by a rotation of the mounting platform 2214 about the axis defined by the shaft 2502. In a further non-limiting aspect, mounting surface 2402 of mounting head 2212 and/or the complementary surface 2408 of the mounting platform 2214 can comprise shapes that facilitate positioning of the mounting platform 2214 in either continuously variable orientations or a set of fixed orientations (e.g., portrait, landscape, etc.) of the mounting platform 2214. Thus, an exemplary embodiment of a cantilevered object mount 2202 can comprise a mounting head 2212 and a mounting platform 2214 that are configured to variably position the mounting platform 2214 in continuously variable orientations (e.g., no preset or predetermined orientations), in a fixed orientation determined by a configuration of the mounting platform 2214, and/or in a subset of a set of fixed orientations determined by the configuration of the mounting platform 2214, about the mounting head 2212, and relative to the complementary surfaces of the target area 2200.

While exemplary embodiments herein depict a shaft 2502 that can facilitate removably securing the mounting platform 2214 to the mounting head 2212, any suitable engagement component may be utilized to removably securing the mounting platform 2214 to the mounting head 2212. Exemplary engagement components may include one or more of bolts, screws, locks, levers, latches, hinges, magnets, clamps, adhesives, any other suitable engagement component, or any combination thereof.

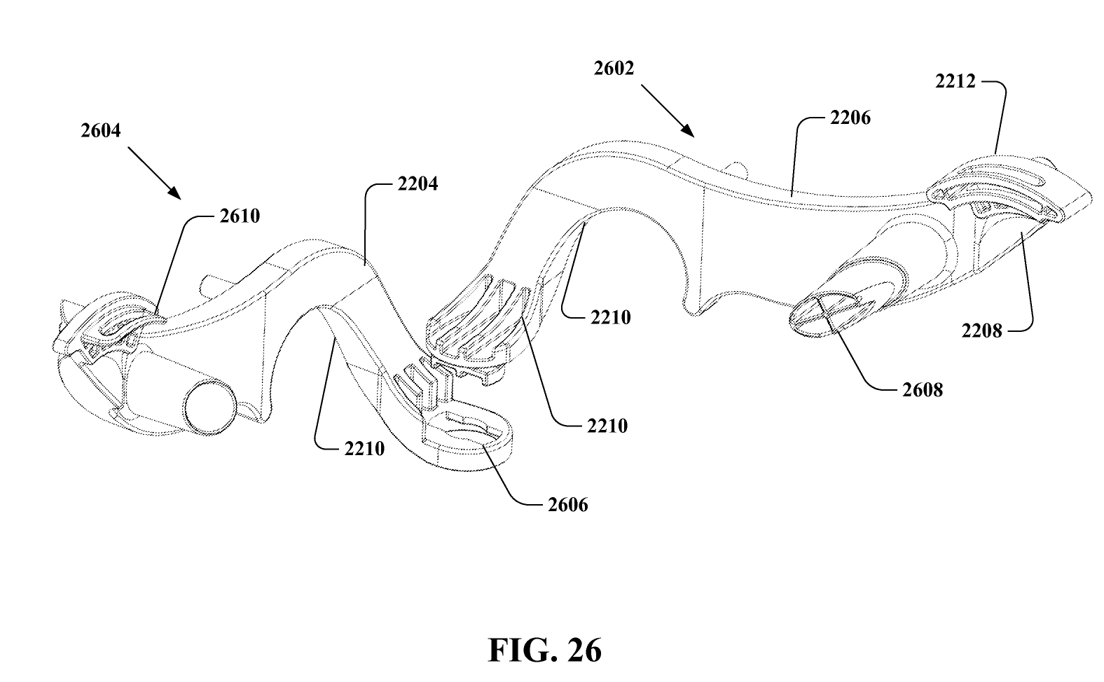

FIG. 26 depicts a further exploded view of an exemplary cantilevered object mount 2202 according to further non-limiting aspects of the present disclosure. In an exemplary embodiment, as depicted herein, a cantilevered object mount 2202 can comprise two interlocking support arms 2602, 2604 that can interlock together. In a non-limiting aspect, interlocking support arms 2602, 2604 can interlock together proximate to the engagement portion 2204, the support portion 2206, and/or the attachment portion 2208 to provide stability to the cantilevered object mount 2202. As a non-limiting example as depicted herein, an exemplary engagement portion 2204 can comprise a key slot interface 2606 that facilitates interlocking the two interlocking support arms 2602, 2604 proximate to the engagement portion 2204. In another non-limiting example, an exemplary support portion 2206 can comprise an interlocking structural post 2608 that facilitates interlocking the two interlocking support arms 2602, 2604 proximate to the support portion 2206. In still another non-limiting example, an exemplary attachment portion 2208, comprising the mounting head 2212, can comprise interleaving mounting head 2212 portions, through which shaft 2502 can pass via mounting head 2212 slot, that facilitates interlocking the two interlocking support arms 2602, 2604 proximate to the attachment portion 2208.

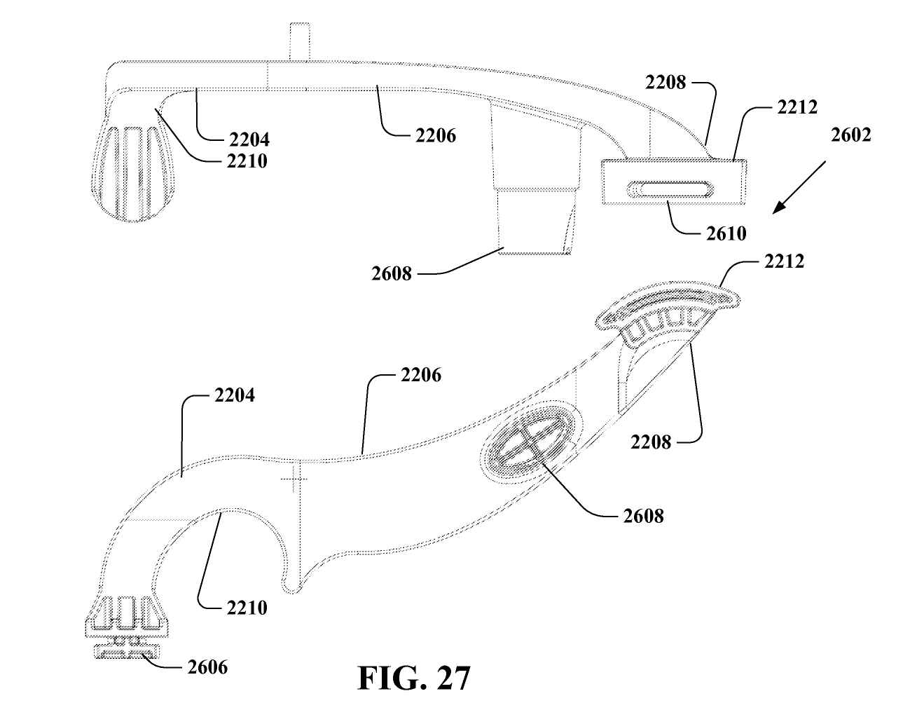

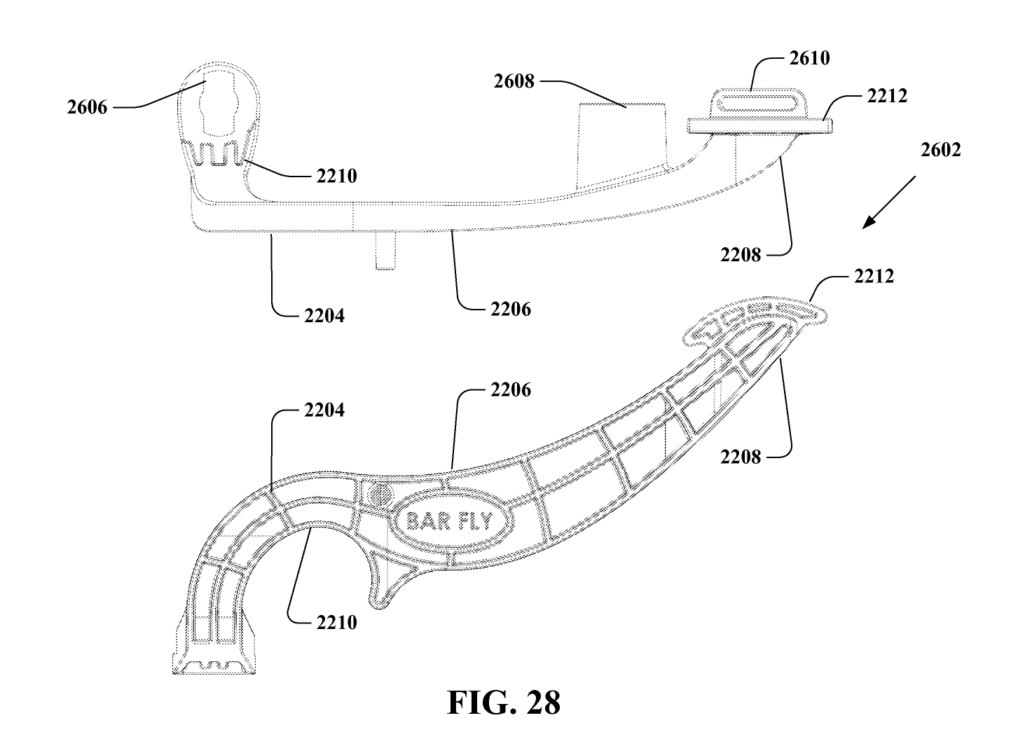

FIG. 27 shows a top view and a front view of an exemplary aspect of cantilevered object mount 2202 (e.g., interlocking support arm 2602) in accordance with embodiments of the present disclosure. FIG. 28 shows a top view and a front view of another exemplary aspect of cantilevered object mount 2202 (e.g., interlocking support arm 2604) in accordance with embodiments of the present disclosure. FIGS. 27-28 depict further aspects of an exemplary embodiment of cantilevered object mount 2202 directed to the key slot interface 2606, interlocking structural post 2608, and interleaving mounting head 2212 portions configured to interlock the two interlocking support arms 2602, 2604.

FIG. 29 shows a top view and an end view of another exemplary aspect of cantilevered object mount 2202 in accordance with embodiments of the present disclosure. For example, FIG. 29 depicts an exemplary mounting platform 2214 comprising a plurality of accessory mounting components 2902 configured to mount any of a plurality of accessories having different dimensions. As a non-limiting example, different accessories that can be located on the mounting platform 2214 of the cantilevered object mount 2202 can comprise a laptop computer, a tablet computer (as depicted in FIG. 23), a bicycle computer, a television, a book, a magazine, a newspaper, a speedometer, a music player, a video player, a telephone, a triathlon watch, a smart phone, or a touch screen device.

Although the cantilevered object mount 2202 comprising a plurality of accessory mounting components 2902 on mounting platform 2214 may be configured in any suitable manner to facilitate removably securing any of a plurality of accessories to the mounting platform 2214, in an exemplary embodiment, accessory mounting components 2902 can comprise a plurality of hooks periodically spaced along a plurality of diametrically opposed mounting platform 2214 arms that radiate out from complementary surface 2408 of the mounting platform 2214. A plurality of hooks can be employed with a plurality of flexible bands (e.g., rubber bands, o-rings, etc.), as depicted in FIG. 23, for example, which can be extended over corresponding edges of any of a plurality of accessories placed on mounting platform 2214 arms to removably secure one of the plurality of accessories to the mounting platform 2214, thereby facilitating location of the object relative to the target area 2200. In other exemplary embodiments, the mounting components 2902 can comprise any of a number or configuration of mounting components 2902 (not depicted) for attaching one or more of a plurality of accessories in any suitable manner, such as a sleeve, a case, an adapter for an attachment component of the accessory, screws, bolts, clamps, adhesives, Velcro®, magnets, any other suitable attachment mechanism, or any combination thereof.

In a further non-limiting aspect, if cantilevered object mount 2202 is attached to bicycle handlebars, an accessory attached to cantilevered object mount 2202 may be located in front of the bicycle handlebars for ease of viewing and/or access. In other exemplary embodiments, mounting platform 2214 may be positioned in a manner such that the mounting platform 2214 and/or one or more of the accessories may be positioned such that a plane defined by at least one of the accessories is positioned in any other suitable manner that defines a desired relationship between a plane corresponding to a mounting platform 2214 and a target area 2200. As further described above regarding FIG. 25, shaft 2502 can comprise a bolt that secures to the mounting platform 2214 at a cavity 2410 in the mounting platform 2214. Although mounting platform 2214 may be removably secured to the mounting head 2512 via shaft 2502 comprising a bolt, in other exemplary embodiments (not depicted), the mounting platform 2214 can be removably secured in any suitable manner. For example, a threaded insert (not depicted) may be inserted (e.g., with a press fit, adhesive, or in any other suitable manner) into cavity 2410 of mounting platform, such that an interior surface of the insert may engage threads of shaft 2502 comprising a bolt. In either case, the tightening of the bolt can cause compression of the mounting surface 2402 of mounting head 2212 against the complementary surface 2408 of the mounting platform 2214 to provide frictional engagement of the of the mounting surface 2402 of mounting head 2212 against the complementary surface 2408 of the mounting platform 2214.

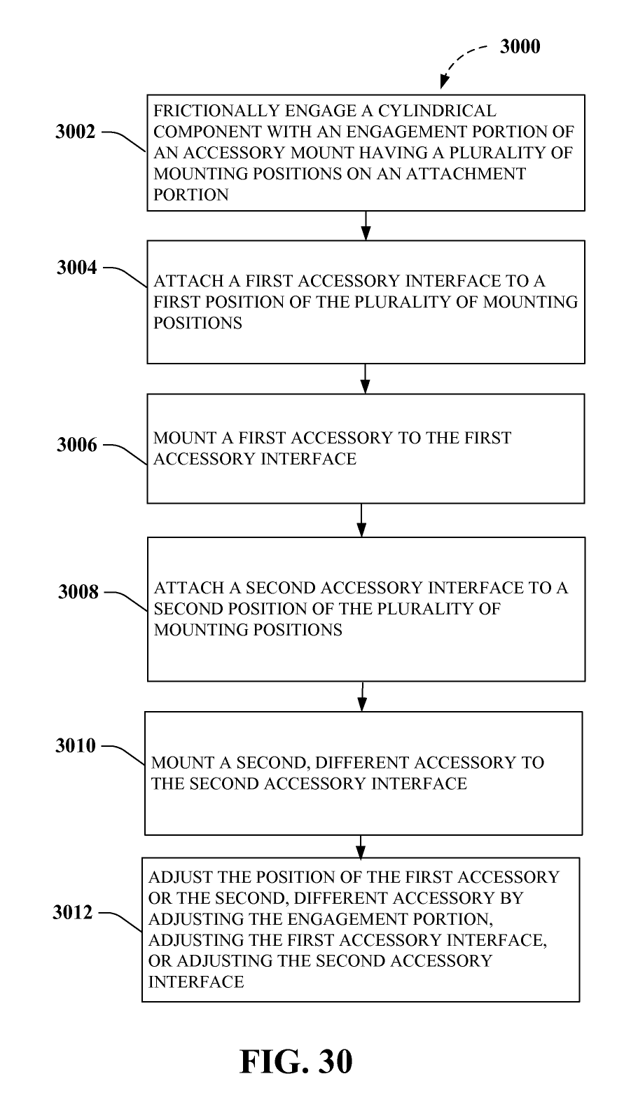

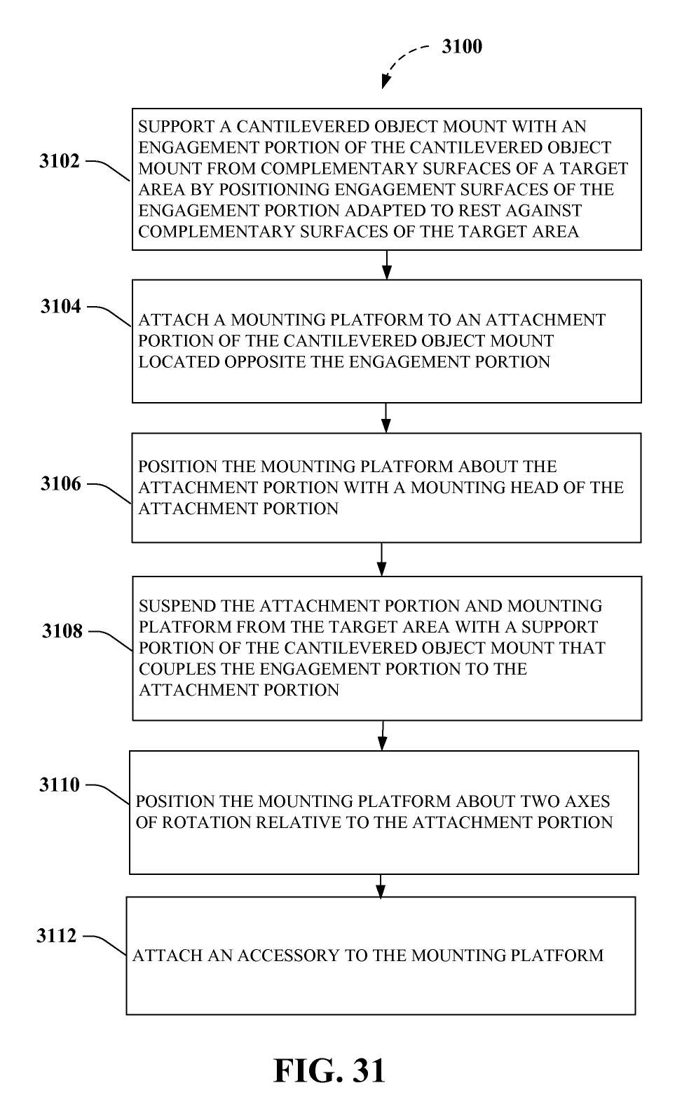

In view of the structures and devices described supra, methods that can be implemented in accordance with the disclosed subject matter will be better appreciated with reference to the flowcharts of FIGS. 30-31. While, for purposes of simplicity of explanation, the methods are shown and described as a series of blocks, it is to be understood and appreciated that such illustrations or corresponding descriptions are not limited by the order of the blocks, as some blocks may occur in different orders and/or concurrently with other blocks from what is depicted and described herein. Any non-sequential, or branched, flow illustrated via a flowchart should be understood to indicate that various other branches, flow paths, and orders of the blocks, can be implemented which achieve the same or a similar result. Moreover, not all illustrated blocks may be required to implement the methods described hereinafter.

### Exemplary Methods

For instance, as described above the disclosed subject matter can provide methods of mounting a plurality of accessories relative to a cylindrical component of a bicycle. In addition, as described above, exemplary methods can comprise locating an object relative to a target area. As can be appreciated, variations in the exemplary methods known to one having ordinary skill in the art may be possible without deviating from the intended scope of the subject matter as claimed.

Thus, FIG. 30 depicts a non-limiting flow diagram 3000 illustrating exemplary methods according aspects of the present disclosure. In an embodiment, exemplary methods 3000 can comprise a method of mounting a plurality of accessories relative to a cylindrical component (e.g., cylindrical component 600, 1200, etc.) of a bicycle. For example, at 3002, exemplary methods 3000 can comprise frictionally engaging the cylindrical component (e.g., cylindrical component 600, 1200, etc.) with an engagement portion (e.g., engagement portion 604, 1204, etc.) of an accessory mount (e.g., accessory mount 602, 1202, etc.) having a plurality of positions for attachment of an accessory or accessory interface on an attachment portion (e.g., attachment portion 608, 1208, etc.).

In a further embodiment, at 3004, exemplary methods 3000 can further comprise attaching a first accessory interface of a plurality of accessory interfaces (e.g., accessory interfaces 618, accessory interfaces 1218, etc.) to a first portion of the attachment portion, and mounting a first accessory to the first accessory interface at 3006. In addition, exemplary methods 3000 can comprise attaching a second accessory interface of the plurality of accessory interfaces (e.g., accessory interfaces 618, accessory interfaces 1218, etc.) to a second portion of the attachment portion, at 3008, and at 3010, mounting a second, different accessory to the second accessory interface. As a non-limiting example of methods 3000, attaching the first accessory interface or attaching the second accessory interface can include fixedly attaching the first accessory interface or the second accessory interface in a selected one of continuously variable orientations, a fixed orientation or a subset of a set of fixed orientations determined by a configuration of the attachment portion (e.g., attachment portion 608, 1208, etc.), about the attachment portion and relative to the cylindrical component (e.g., cylindrical component 600, 1200, etc.) of the bicycle.

In a non-limiting aspect of methods 3000, attaching the first accessory interface and the attaching the second accessory interface can include attaching the first accessory interface and the second accessory interface on opposite sides of the attachment portion (e.g., attachment portion 608, 1208, etc.). In another non-limiting aspect of methods 3000, attaching the first accessory interface to the first position of one or more mounting positions can include integrally forming the first accessory interface with a portion of the attachment portion (e.g., attachment portion 608, 1208, etc.), as further described herein. In addition, exemplary methods 3000 and further comprise positioning a first one of the mounting positions along a first plane that is substantially tangentially aligned with the cylindrical component (e.g., cylindrical component 600, 1200, etc.) or positioning a second one of the mounting positions along a second plane that is substantially aligned with a longitudinal axis that is centrally located along the cylindrical component (e.g., cylindrical component 600, 1200, etc.), or at any vertical or horizontal offset with respect to the cylindrical component.

In a further non-limiting example, mounting the first accessory and mounting the second, different accessory can include mounting one or more different accessories to the attachment portion (e.g., attachment portion 608, 1208, etc.), as further described herein. For instance, exemplary methods 3000 can comprise mounting two or more of a bicycle computer, a speedometer, a global positioning system device, a music player, a telephone, a triathlon watch, a smart phone, a mobile transmitters, a wireless communication device, a camera, or a touch screen device to the accessory mount (e.g., accessory mount 602, 1202, etc.).

In a further embodiment, at 3012, exemplary methods 3000 can further comprise adjusting the positioning of the first accessory or the second, different accessory by adjusting the engagement portion (e.g., engagement portion 604, 1204, etc.), adjusting the first accessory interface, or adjusting the second accessory interface. In addition, exemplary methods 3000 can further comprise supporting the first and second, different accessory from the engagement portion (e.g., engagement portion 604, 1204, etc.) with an extension portion (e.g., extension portion 806, extension portion 1406, etc.) that primarily extends from the engagement portion (e.g., engagement portion 604, 1204, etc.) along a plane perpendicular to a longitudinal axis that is centrally located along the cylindrical component (e.g., cylindrical component 600, 1200, etc.), and positioning the attachment portion (e.g., attachment portion 608, 1208, etc.) at an offset to the extension portion.

FIG. 31 depicts another non-limiting flow diagram illustrating exemplary methods 3100 according aspects of the present disclosure. As a non-limiting example, exemplary methods 3100 of locating an object relative to a target area can comprise, at 3102, supporting a cantilevered object mount 2202 with an engagement portion 2204 of the cantilevered object mount 2202 from complementary surfaces of the target area 2200 by positioning a plurality of engagement surfaces 2210 of the engagement portion 2204 adapted to rest against the complementary surfaces of the target area 2200. For instance, exemplary methods 3100 can comprise assembling two interlocking support arms 2602, 2604 that interlock proximate to the engagement portion 2204, to the support portion 2206, or to the attachment portion 2208. In a further non-limiting aspect of exemplary methods 3100, positioning a plurality of engagement surfaces can further comprise positioning a first surface (e.g., engagement surface 2210) adapted to rest underneath a stem of a bicycle and positioning a second surface (e.g., engagement surface 2210) adapted to rest about a surface of a handlebar of the bicycle.

In addition, exemplary methods 3100 can comprise attaching a mounting platform 2214 to an attachment portion 2208 of the cantilevered object mount 2202 located opposite the engagement portion 2204, at 3104, and positioning the mounting platform 2214 about the attachment portion 2208 with a mounting head 212 of the attachment portion 2208 at 3106. As a non-limiting example, attaching the mounting platform 2214 can include attaching the mounting platform 2214 to a mounting surface 2402 of the mounting head 2212, defined by an arc 2406 about the attachment portion 2208, that engages a complementary surface 2408 of the mounting platform 2214, or rotating the mounting platform 2214 about the arc 2406 in a forward or aft rotation of the mounting platform 2214 about the mounting head 2212. In another non-limiting aspect of exemplary methods 3100, attaching the mounting platform 2214 can comprise securing the mounting platform 2214 to the mounting head with a shaft 2502 that passes through the mounting surface 2402 and is positioned substantially orthogonal to a plane of the mounting platform 2214 which receives the object, or rotating the mounting platform 2214 about an axis defined by the shaft 2502.

In other non-limiting embodiments, at 3108, exemplary methods 3100 can comprise suspending the attachment portion 2208 and mounting platform 2214 from the target area 2200 with a support portion 2206 of the cantilevered object mount 2202 that couples the engagement portion 2204 to the attachment portion 2208.

In addition, non-limiting embodiments of the exemplary methods 3100 can further comprise positioning the mounting platform 2202 about two axes of rotation relative to the attachment portion 2208, at 3110. For instance, in a non-limiting aspect, exemplary methods 3100 can include rotating the mounting platform 2214 about the arc 2406 in the forward or aft rotation of the mounting platform 2214 about the mounting head 2212 and rotating the mounting platform 2214 about the axis defined by the shaft 2502. In a further non-limiting example, exemplary methods 3100 can comprise positioning the mounting platform 2114 in a selected one of a set of continuously variable orientations, a fixed orientation, or a subset of a set of fixed orientations, about the attachment portion 2208 and relative to the complementary surfaces of a bicycle.

Moreover, exemplary embodiments of methods 3100 can further comprise, 3112, attaching an accessory to the mounting platform 2214, comprising a laptop computer, a tablet computer, a bicycle computer, a speedometer, a music player, a book, a magazine, a television, a video player, a telephone, a triathlon watch, a smart phone, or a touch screen device, etc.

The foregoing is merely illustrative of the principles of this disclosure and various modifications may be made by those skilled in the an without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications in accessory mounting design and/or manufacturing. Therefore, the disclosed subject matter should not be limited to any single embodiment described herein, but rather should be construed in breadth and scope in accordance with the appended claims.

What is claimed is:

1. An accessory mount for positioning a plurality of accessories relative to a cylindrical component of a bicycle, comprising:
an engagement portion defining an engagement surface adapted to frictionally engage the cylindrical component;
an attachment portion to fixedly attach a plurality of accessory interfaces to the accessory mount, wherein the attachment portion is configured for simultaneous attachment of the plurality of accessory interfaces; and
a support portion that couples the engagement portion to the attachment portion.

2. The accessory mount of claim 1, wherein the attachment portion and the plurality of accessory interfaces are configured to fixedly attach the plurality of accessory interfaces in at least one of a selected one of a set of continuously variable orientations, a fixed orientation determined by a configuration of the attachment portion, or a subset of a set of fixed orientations determined by the configuration of the attachment portion, about the attachment portion and relative to the cylindrical component of the bicycle.

3. The accessory mount of claim 1, wherein the plurality of accessory interfaces are configured for simultaneous attachment of a plurality of different accessories to the attachment portion.

4. The accessory mount of claim 3, further comprising:
a first accessory interface of the plurality of accessory interfaces configured to locate a first accessory of the plurality of accessories to a first position of the attachment portion; and
a second accessory interface of the plurality of accessory interfaces configured to locate a second accessory of the plurality of accessories to a second position of the attachment portion.

5. The accessory mount of claim 1, wherein the engagement portion of the accessory mount employs an eccentric spacer between the engagement surface and the cylindrical component of the bicycle to position the accessory mount and frictionally engage the cylindrical component of the bicycle.

6. The accessory mount of claim 1, wherein at least one accessory interface is integrally formed with at least a portion of the attachment portion.

7. The accessory mount of claim 1, wherein the support portion further comprises:
an extension portion that primarily extends from the engagement portion along a plane perpendicular to a longitudinal axis that is centrally located along the cylindrical component; and
a positioning portion that locates the attachment portion at an offset to the extension portion.

8. The accessory mount of claim 7, wherein the attachment portion comprises a plurality of mounting surfaces, wherein each of the plurality of mounting surfaces is adapted to attach one of the plurality of accessory interfaces.

9. The accessory mount of claim 7, wherein two of the plurality of mounting surfaces are located on opposite sides of the attachment portion

10. The accessory mount of claim 1, wherein a plane defined by a surface of the attachment portion is substantially tangentially aligned with the cylindrical component.

11. The accessory mount of claim 1, wherein a plane defined by a surface of the attachment portion is substantially aligned with the longitudinal axis of the cylindrical component.

12. A method of mounting a plurality of accessories to a cylindrical component of a bicycle, comprising:
frictionally engaging the cylindrical component with an engagement portion of an accessory mount having a plurality of mounting positions on an attachment portion;
attaching a first accessory interface of a plurality of accessory interfaces to a first position of the plurality of mounting positions;
mounting a first accessory to the first accessory interface;
attaching a second accessory interface of the plurality of accessory interfaces to a second position of the plurality of mounting positions; and
mounting a second, different accessory to the second accessory interface.

13. The method of claim 12, wherein the mounting the first accessory and the mounting the second, different accessory comprises mounting of a plurality of different accessories to the attachment portion.

14. The method of claim 12, wherein the first accessory and the second, different accessory are supported from the engagement portion by an extension portion that primarily extends from the engagement portion along a plane perpendicular to a longitudinal axis that is centrally located along the cylindrical component and that positions the attachment portion at an offset to the extension portion.

15. The method of claim 12, wherein the attaching the first accessory interface and the attaching the second accessory interface comprise attaching the first accessory interface and the second accessory interface on opposite sides of the attachment portion.

16. A cantilevered object mount for locating an object relative to a target area, comprising:
an engagement portion of the cantilevered object mount defining a plurality of engagement surfaces adapted to rest against complementary surfaces of the target area and employ weight of the cantilevered object mount to securely engage the cantilevered object mount on the target area;
an attachment portion of the cantilevered object mount comprising a mounting head to fixedly attach a mounting platform to the cantilevered object mount, wherein the mounting head is configured to variably position the mounting platform; and
a support portion of the cantilevered object mount that couples the engagement portion to the attachment portion.

17. The cantilevered object mount of claim 16, wherein the mounting head further comprises:
a mounting surface, defined by an arc about the attachment portion, that engages a complementary surface of the mounting platform, wherein the arc is oriented to allow forward and aft rotation of the mounting platform about the mounting head.

18. The cantilevered object mount of claim 17, wherein the cantilevered object mount further comprises a shaft that passes through the mounting surface and removably secures the mounting platform to the mounting head, wherein the shaft is oriented substantially orthogonal to a plane of the mounting platform that receives the object.

19. The cantilevered object mount of claim 18, wherein the mounting surface and the shaft that passes through the mounting surface removably secure the mounting platform to the mounting head and allow rotation of the mounting platform about an axis defined by the shaft.

20. The cantilevered object mount of claim 19, wherein the mounting head is configured to variably position the mounting platform about two axes of rotation relative to the attachment portion.

21. The cantilevered object mount of claim 20, wherein the two axes of rotation comprise the forward and aft rotation of the mounting platform and the rotation of the mounting platform about the axis defined by the shaft.

22. The cantilevered object mount of claim 16, wherein the mounting head and mounting platform are configured to variably position the mounting platform in at least one of a selected one of a set of continuously variable orientations, a fixed orientation determined by a configuration of the mounting platform, or a subset of a set of fixed orientations determined by the configuration of the mounting platform, about the mounting platform, and relative to the complementary surfaces of the target area.

23. The cantilevered object mount of claim 16, wherein a portion of a bicycle comprises the target area, and wherein the plurality of engagement surfaces comprises a first surface adapted to rest underneath a stem of the bicycle and a second surface adapted to rest about a surface of a handlebar of the bicycle.

24. The cantilevered object mount claim 16, wherein the mounting platform comprises a plurality of accessory mounting components configured to mount one or more of a plurality of accessories having different dimensions.

25. The cantilevered object mount of claim 24, wherein the plurality of accessories includes at least one of a laptop computer, a tablet computer, a bicycle computer, a speedometer, a music player, a video player, a telephone, a television, a book, a magazine, a triathlon watch, a smart phone, a camera, or a touch screen device.

26. The cantilevered object mount of claim 16, wherein the cantilevered object mount comprises two interlocking support arms that interlock proximate to at least one of the engagement portion, the support portion, or the attachment portion.

27. The cantilevered object mount of claim 26, wherein the engagement portion further comprises a key slot interface that interlocks the two interlocking support arms.

28. The cantilevered object mount of claim 26, wherein the mounting head interlocks the two interlocking support arms.

29. A method of locating an object relative to a target area, comprising:
supporting a cantilevered object mount with an engagement portion of the cantilevered object mount from complementary surfaces of the target area by positioning a plurality of engagement surfaces of the engagement portion adapted to rest against the complementary surfaces of the target area;
attaching a mounting platform to an attachment portion of the cantilevered object mount located opposite the engagement portion and positioning the mounting platform about the attachment portion with a mounting head of the attachment portion; and
suspending the attachment portion and mounting platform from the target area with a support portion of the cantilevered object mount that couples the engagement portion to the attachment portion.

30. The method of claim 29, wherein the positioning the plurality of engagement surfaces comprises positioning a first surface adapted to rest underneath a stem of a bicycle and positioning a second surface adapted to rest about a surface of a handlebar of the bicycle.
